(19) United States
(12) Patent Application Publication
(10) Pub. No.: US 2026/0018955 A1
(43) Pub. Date: Jan. 15, 2026

(54) MOTOR AND COMPRESSOR

(71) Applicant: AICHI ELECTRIC CO., LTD., KASUGAI-SHI (JP)

(72) Inventors: Masahiro HASEGAWA, Kasugai-shi (JP); Shoya ENOMOTO, Kasugai-shi (JP)

(21) Appl. No.: 19/262,470

(22) Filed: Jul. 8, 2025

(30) Foreign Application Priority Data
Jul. 9, 2024 (JP) 2024-110308

(51) Int. Cl. H02K 3/52; F25B 31/02

(52) U.S. Cl. CPC H02K 3/522; F25B 31/02; H02K 2203/06; H02K 2203/12

(57) ABSTRACT

A motor (310) includes a stator (100; 100b; 100c; 100d; 100e), and a connection member (52) configured to hold at least one connection terminal (94). An electrical insulation body (70; 70b; 70c; 70d; 70e) includes at least one drum part (714) disposed on an end portion on a first side in an axial direction (DZ) of a tooth base part (842), and at least one inner wall part (716) disposed on an end portion on the first side in the axial direction of a tooth tip part (844). The connection member is disposed on the first side in the axial direction of the stator. A bottom part (528; 558) is disposed in a first region (H1) that is radially inward of an outer wall part (712), and is disposed further toward a second side in the axial direction than an outer apex part (712T) of the outer wall part.

### CROSS-REFERENCE TO RELATED APPLICATIONS

The present application claims priority to Japanese patent application nos. 2024-110308 filed on Jul. 9, 2024. The contents of the foregoing application are hereby fully incorporated herein by reference.

### TECHNICAL FIELD

The present disclosure relates to an electric motor and a compressor driven by the electric motor.

### BACKGROUND ART

It is known to mount an electric motor on or in a compressor to drive it. Such a motor includes at least one lead wire that is electrically connected with a power source, such as an inverter included in the compressor, and the motor includes a connection member disposed at (on) an end portion on the inverter side. The lead wire is disposed inside the connection member, and a conductive terminal of the inverter is electrically connected to the lead wire inside the connection member. For example, JP 2019-213415 A discloses a motor in which a connection member is disposed at (on) an end portion on the inverter side in the motor, using a to-be-engaged part formed in the connection member and an engagement part provided at an end portion of an electrical insulation body contained in the motor.

### SUMMARY

In the above-described related art, since the connection member is disposed on the end portion on the inverter side in the motor, it could cause (require) the length of the compressor to become larger in an axial direction. Thus, there is a need for a technique that can more efficiently position the connection member so that the size of the compressor can be reduced. For example, when the compressor is to be installed in a vehicle, the space for disposing the compressor in the vehicle is limited, and this type of problem thus becomes particularly evident.

Representative, non-limiting aspects of the present disclosure are summarized below.

(1) According to one aspect of the present disclosure, a motor may include a stator having a cylindrical shape and extending in an axial direction, and a connection member including a side wall part, a bottom part, and a terminal space defined by the side wall part and the bottom part. The connection member is configured for at least one connection terminal, which is electrically connected to at least one conductive terminal from a power supply, to be disposed in the terminal space. The stator includes a stator core having a yoke extending in a circumferential direction and teeth extending toward an inner side in a radial direction (radially inward) from the yoke, an electrical insulation body mounted on the stator core, and at least one stator winding wound on the stator core via (over) the electrical insulation body. Each of the teeth includes a tooth base part extending toward the inner side in the radial direction (radially inward) from the yoke, and a tooth tip part continuous with a (radially inward) tip end on the inner side in the radial direction of the tooth base part. The electrical insulation body includes an outer wall part disposed on an end portion on a first side in the axial direction of the yoke, the outer wall part including at least one outer apex part that is an (a radially inward) end portion on the first side in the radial direction of the outer wall part, at least one drum part disposed on an end portion on the first side in the axial direction of the (at least one) tooth base part, and at least one inner wall part disposed on an end portion on the first side in the axial direction of the (at least one) tooth tip part. The connection terminal is attached to one (a first) end of the (at least one) stator winding. The connection member is disposed on the first side in the axial direction of the stator. The bottom part is disposed in a first region that is radially inward of the outer wall part and is located further toward a second side in the axial direction than the outer apex part.

According to the motor of this embodiment, compared to an embodiment in which a connection member is disposed on an end portion of a motor, the connection member can be disposed in a more efficient (space saving) manner, and thus the length of the motor in the axial direction can be shortened. Consequently, the size of the compressor can be reduced.

(2) In one embodiment of the motor as defined in the above-described aspect, the (at least one) stator winding may include a coil wound on the stator core (more specifically, on one of teeth thereof) via (over, around) the electrical insulation body, and a lead wire part that includes the one (first) end of the stator winding and electrically connects the coil and the connection terminal. The bottom part may be disposed in a second region within the first region, the second region extending from an end portion on the first side in the axial direction of the coil to the outer apex part.

According to the motor of this embodiment, the position of the connection member is set based on an arrangement relationship with the coil, such that the length of the motor in the axial direction can be shortened compared to the related art.

(3) In another embodiment of the motor as defined in the above-described aspect, the bottom part may be disposed in a third region within the first region, the third region extending in the axial direction from an inner apex part, which is an end portion on the first side in the axial direction of the inner wall part, to the outer apex part.

According to the motor of this embodiment, even if one or more members other than the connection member are disposed in the axial direction between the inner apex part and the outer apex part, the length of the motor in the axial direction can still be shortened compared to the related art.

(4) In another embodiment of the motor as defined in the above-described aspect, the outer wall part may include a (at least one) longest wall portion having a length that is longest in the axial direction of the outer wall part, and a shortest wall portion having a length that is shortest in the axial direction of the outer wall part, wherein the length of the shortest wall portion is equal to or greater than a length of the inner wall part in the axial direction. The bottom part may be disposed in a fourth region within the third region, the fourth region extending in the axial direction from the inner apex part to a shortest outer apex part that is an end portion on the first side in the axial direction of the shortest wall part.

According to the motor of this embodiment, the length of the motor in the axial direction can be shortened compared to the related art, while the length in the axial direction of the longest wall part can be longer than the length in the axial direction of an outer wall part of the related art.

(5) In another embodiment of the motor as defined in the above-described aspect, the bottom part may be disposed at a position in contact with the (at least one) inner apex part.

According to the motor of this embodiment, compared to an embodiment in which the connection member is disposed on the end portion of the motor, the length of the motor in the axial direction can be shortened.

(6) In another embodiment of the motor as defined in the above-described aspect, the (at least one) stator winding may include a coil wound on the stator core (more specifically, one of the teeth thereof) via (over, around) the electrical insulation body, and a lead wire part that includes the one (first) end of the stator winding and electrically connects the coil and the connection terminal. At least a portion of the lead wire part may be disposed further toward an outer side in the radial direction than (radially outward of) the outer wall part.

According to the motor of this embodiment, in a region further toward the inner side in the radial direction than (radially inward of) the outer wall part and further toward the second side in the axial direction than the outer apex part, a region in which the connection member can be disposed can be made larger.

(7) In another embodiment of the motor as defined in the above-described aspect, the outer wall part may include a groove that holds (accommodates) the lead wire part in a (radially outer) wall surface on the outer side in the radial direction of the outer wall part.

According to the motor of this embodiment, an assembly step to dispose the lead wire part further toward the outer side in the radial direction than (radially outward of) the outer wall part can be made easier.

(8) The motor as defined in the above-described aspect may further include a support member connected to the connection member. The support member may be configured to be in contact with a plurality of locations of the electrical insulation body disposed on the first side in the axial direction of the stator.

According to the motor of this embodiment, by using the support member, the connection member can be supported by (on) the electrical insulation body via a plurality of contact points. Thus, the connection member can be disposed on the stator in a stable state (manner).

(9) In another embodiment of the motor as defined in the above-described aspect, the support member may include an outer peripheral wall part connected to the connection member and extending in the circumferential direction. The outer peripheral wall part may be disposed facing a (radially outer) wall surface on an outer side in the radial direction of the outer wall part, further toward the outer side in the radial direction than (radially outward of) the outer wall part.

According to the motor of this embodiment, the outer wall part of the electrical insulation body can be protected by the support member. Further, by designing the electrical insulation body to support the support member, wobbling of the connection member and the support member can be curtailed or even prevented.

(10) In another embodiment of the motor as defined in the above-described aspect, the support member may include a first engagement part. The electrical insulation body may include a second engagement part configured to engage with the first engagement part.

According to the motor of this embodiment, movement of the support member relative to the electrical insulation body is restricted (blocked), and the connection member and the support member can be disposed on the stator in a stable state (manner).

(11) In another embodiment of the motor as defined in the above-described aspect, the support member may include an outer peripheral wall part connected to the connection member and extending in the circumferential direction, and an outer peripheral wall flange protruding toward the inner side in the radial direction (radially inward) from the outer peripheral wall part, and extending in the circumferential direction. The first engagement part may include at least a portion of the outer peripheral wall flange. The second engagement part may include a base part protruding from the outer apex part toward the first side in the axial direction, and a claw part protruding toward an outer side in the radial direction (radially outward) from the base part. At least a portion of the outer peripheral wall flange may be engaged between the claw part and the outer apex part.

According to the motor of this embodiment, by designing the second engagement part with a snap fit structure, the first engagement part and the second engagement part can be easily and securely engaged by performing a simple method.

(12) In another embodiment of the motor as defined in the above-described aspect, the first engagement part may include a protrusion protruding toward an outer side in the radial direction (radially outward) from the support member. The second engagement part may include a recess or a through hole corresponding (complementary) to the protrusion and formed in a (radially inner) wall surface on the inner side in the radial direction of the outer wall part. The protrusion may be configured to be engaged (inserted) in the recess or the through hole.

According to the motor of this embodiment, the first engagement part and the second engagement part can be caused to engage further toward a second side in the axial direction than the outer apex part. Thus, the configuration of the motor on the first side in the axial direction can be simplified.

(13) In another embodiment of the motor as defined in the above-described aspect, the support member may include an outer peripheral wall part connected to the connection member and extending in the circumferential direction. The outer peripheral wall part may include an outer peripheral wall flange protruding toward the inner side in the radial direction (radially inward) and extending in the circumferential direction. The outer wall part may include a fitting part having one of a convex shape or a concave shape. The outer peripheral wall flange may include a to-be-fitted part having the other of the convex shape or the concave shape so as to correspond (be complementary) to the fitting part.

According to the motor of this embodiment, movement of the outer peripheral wall part can be restricted (blocked), and the connection member and the support member can be disposed on the stator in the stable state (manner).

(14) In another embodiment of the motor as defined in the above-described aspect, the support member may include an inner peripheral wall part connected to the connection member and extending in the circumferential direction. At least a portion of the inner peripheral wall part may be configured to be in contact with the (at least one) inner apex part that is an end portion on the first side in the axial direction of the (at least one) inner wall part.

According to the motor of this embodiment, movement of an inner peripheral portion of the support member is restricted (blocked), and the connection member and the support member can be disposed on the stator in the stable state (manner).

(15) In another embodiment of the motor as defined in the above-described aspect, the (at least one) stator winding may include a coil wound on the stator core via (over, around) the electrical insulation body, and a lead wire part that includes the one (first) end of the stator winding and electrically connects the coil and the connection terminal. The support member may include a lead wire compartment configured to guide the lead wire part to the connection member.

According to the motor of this embodiment, by using such a support member, the lead wire part of the (at least) stator winding can be disposed on the stator in a stable state.

(16) In another embodiment of the motor as defined in the above-described aspect, the (at least one) stator winding may further include a wire connection part that includes the other (second) end of the stator winding and serves as a neutral point of stator windings that are Y-connected. The support member may further include a wire connection terminal compartment configured to house a wire connection terminal for connecting the other end of the stator winding as a neutral point connection.

According to the motor of this embodiment, by using such a support member, the wire connection part can be disposed on the stator in a stable state.

(17) In another embodiment of the motor as defined in the above-described aspect, the motor may further include a cover member. The cover member may include a connection member lid part, which has an opening for inserting the conductive terminal and being disposed facing the bottom part, and a lead wire lid part configured to face the lead wire compartment.

According to the motor of this embodiment, the connection terminal disposed on the connection member, as well as the lead wire part disposed in the lead wire compartment, can be protected from an external environment and the like.

(18) In another embodiment of the motor as defined in the above-described aspect, the cover member may further include an inclined part that is inclined at a prescribed angle relative to the bottom part, the angle being formed between the opening and the lead wire lid part. The prescribed angle may be in a range of 15 degrees to 45 degrees.

According to the motor of this embodiment, it is possible to reduce the likelihood of or even prevent a defect when laser welding (bonding, fusing) the cover member to the connection member.

(19) In another embodiment of the motor as defined in the above-described aspect, the motor may be designed to be used in a compressor installed in a vehicle.

(20) According to another aspect of the present disclosure, a compressor may include a compression mechanism that compresses a fluid and discharges (outputs) compressed fluid, and a motor that drives the compression mechanism. The motor may be designed according to any one of the above-described or below-described aspects and embodiments.

The present disclosure can be realized by various aspects other than the above- or below-described motor or compressor. For example, the present disclosure can be realized by a connection member, a support member including the connection member, a stator, a method of manufacturing the stator, a method of arranging the connection member, a method of manufacturing the motor, a method of manufacturing the compressor, a method of manufacturing the connection member, a method of manufacturing the support member including the connection member, and the like.

### BRIEF DESCRIPTION OF THE DRAWINGS

FIG. 1 is an explanatory view showing internal structures of a compressor equipped with a motor according to a first embodiment.

FIG. 2 is an explanatory view showing a configuration of the motor according to the first embodiment of the present disclosure.

FIG. 3 is an exploded perspective view showing configurations of each of parts of the motor.

FIG. 4 is an explanatory view showing a configuration of a stator.

FIG. 5 is a sectional view of cross-section V-V shown in FIG. 4.

FIG. 6 is a perspective view showing an external configuration of an electrical insulation body.

FIG. 7 is a plan view showing a configuration of a connection member and a support member.

FIG. 8 is a perspective view showing the configuration of the connection member and the support member.

FIG. 9 is an explanatory view showing a method (scheme) for arranging lead wire parts and wire connection parts of a stator winding.

FIG. 10 is a perspective view showing a configuration of a wire connection terminal.

FIG. 11 is an explanatory view showing the wire connection part that is connected as a neutral point by using the wire connection terminal.

FIG. 12 is a perspective view showing a configuration of an outer peripheral wall part.

FIG. 13 is a sectional view of cross-section XIII-XIII shown in FIG. 12.

FIG. 14 is a perspective view showing a configuration on a second side in an axial direction of the support member.

FIG. 15 is a sectional view of cross-section XV-XV shown in FIG. 7.

FIG. 16 is a sectional view of cross-section XVI-XVI shown in FIG. 2.

FIG. 17 is a perspective view showing an external configuration of a cover member.

FIG. 18 is a side view of the cover member.

FIG. 19 is an explanatory view showing a modified example of an arrangement position of the connection member.

FIG. 20 is an explanatory view showing a configuration of a motor according to a second embodiment.

FIG. 21 is an exploded perspective view showing a configuration of parts of the motor according to the second embodiment.

FIG. 22 is a plan view of the motor according to the second embodiment.

FIG. 23 is an explanatory view showing a configuration of an electrical insulation body of the second embodiment.

FIG. 24 is an explanatory view showing a configuration of a support member of the second embodiment.

FIG. 25 is a sectional view of cross-section XXV-XXV shown in FIG. 22.

FIG. 26 is an explanatory view showing a configuration of a cover member of the second embodiment.

FIG. 27 is a perspective view showing a configuration of the second side in the axial direction of the support member.

FIG. 28 is a sectional view of cross-section XXVIII-XXVIII shown in FIG. 22.

FIG. 29 is an explanatory view showing a configuration of a motor according to a third embodiment of the present disclosure.

FIG. 30 is a perspective view showing a configuration on the second side in the axial direction of a support member of the third embodiment.

FIG. 31 is an explanatory view showing a configuration of a side of an electrical insulation body of the third embodiment.

FIG. 32 is a sectional view of cross-section XXXII-XXXII shown in FIG. 29.

FIG. 33 is an exploded perspective view showing a configuration of a stator included in a motor according to another embodiment.

FIG. 34 is an exploded perspective view showing a configuration of a stator included in a motor according to another embodiment.

### DETAILED DESCRIPTION OF THE EMBODIMENTS

### A. First Embodiment

### A1. Configuration of Compressor 300

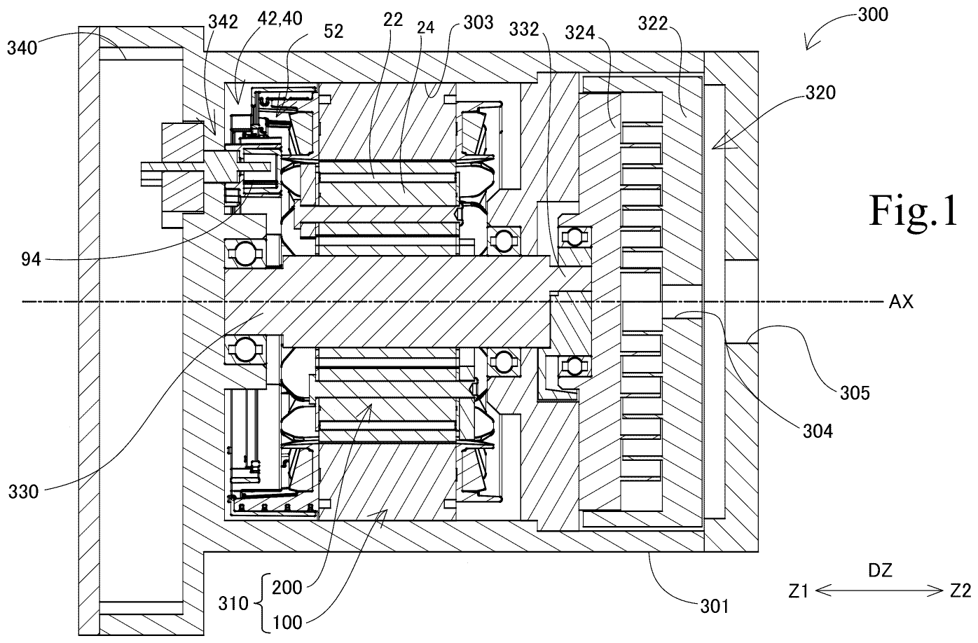

FIG. 1 is an explanatory view showing internal structures of a compressor 300 equipped with a motor 310 according to a first embodiment of the present disclosure. The compressor 300 is configured, for example, as an electric scroll compressor. For example, the compressor 300 may be installed in a vehicle (not shown in the drawings), and is provided in a refrigerating circuit (air conditioning system) of an in-vehicle air conditioner, together with other components such as an evaporator, an expansion valve, a condenser and the like. The compressor 300 takes in a refrigerant of the in-vehicle air conditioning system, condenses the refrigerant, and discharges condensed refrigerant.

As shown in FIG. 1, the compressor 300 includes a housing 301, the motor 310, a compression mechanism 320 that compresses and supplies (outputs) compressed fluid, a drive shaft 330, and a power supply circuit (regulated power supply) 340. The housing 301 houses the motor 310 and the compression mechanism 320. A motor chamber 303, in which the motor 310 is arranged, and a discharge port 305 are formed (defined) in the housing 301.

The motor chamber 303 is fluidly connected, e.g., to the evaporator via an intake port (not shown in the drawings). The refrigerant supplied from the evaporator flows into the motor chamber 303 via the intake port. The discharge port 305 discharges the high pressure refrigerant compressed by the compression mechanism 320 to the outside of the compressor 300. The discharge port 305 is fluidly connected, for example, to the condenser (not shown in the drawings).

The drive shaft 330 is a substantially cylindrical member extending along a rotational axis AX. The drive shaft 330 is supported inside the housing 301 so as to be rotatable about the rotational axis AX. An eccentric pin 332 having a substantially cylindrical shape is formed at (extends from) an end portion of the drive shaft 330. The eccentric pin 332 is arranged at a position offset by a prescribed distance from the rotational axis AX.

The power supply circuit 340 is, for example, an inverter or the like configured to drive (energize) the motor 310. The power supply circuit 340 converts a DC current supplied from a battery, which is a power source installed in the vehicle, into an AC current, and supplies the converted AC current to the motor 310. In the present embodiment, a three-phase current is supplied to the motor 310.

The power supply circuit 340 includes conductive terminals 342. The conductive terminals 342 are respectively electrically connected to connection terminals 94 of a stator 100. The connection terminals 94 are arranged (disposed) inside a connection member 52. As a result of this, the power supply circuit 340 is electrically connected to the motor 310.

The motor 310 generates a rotational driving force to rotate the drive shaft 330 about the rotational axis AX. The motor 310 is an example of a “motor” according to the present teachings. In the present embodiment, a description is given using an example in which the motor 310 is an inner rotor type motor. The motor 310 includes the stator 100 having a substantially cylindrical shape, and a rotor 200. Note that, in other embodiments of the present teachings, the motor 310 may instead be an outer rotor type motor; i.e. the rotor radially surrounds the stator.

The stator 100 is fixed in the motor chamber 303. The stator 100 rotates the rotor 200 using varying magnetic fields generated by the AC current supplied from the power supply circuit 340.

The rotor 200 is arranged inside the stator 100 so as to be able to rotate relative to the stator 100. The rotor 200 includes a cylindrical rotor core 24, magnets 22 fixed (embedded) in the interior (or fixed to the surface of) the rotor core 24, and the drive shaft 330 rotatably supported in the center of the rotor core 24. The rotor core 24 is formed by stacking (laminating) core pieces (sheets) made of electrical steel. The magnets 22 are, for example, permanent magnets containing (composed of) neodymium, iron, together with boron and the like. Each magnet 22 has a flat plate shape that is elongated along an axial direction of the rotor core 24. The drive shaft 330 is rotated about the rotational axis AX when the rotor 200 is rotated.

The compression mechanism 320 includes a fixed scroll 322, and a movable scroll 324. The movable scroll 324 is connected to the drive shaft 330 via the eccentric pin 332. The fixed scroll 322 is fixed to the housing 301. A fluid communication path 304 is formed in the fixed scroll 322. The fixed scroll 322 and the movable scroll 324 respectively have wall surfaces arranged in a helical shape, and the helically-shaped wall surfaces are arranged to mesh (to be interleaved) with each other. As a result, a compression chamber capable of compressing the refrigerant is formed between the fixed scroll 322 and the movable scroll 324. When the motor 310 is energized and the drive shaft 330 rotates about the rotational axis AX, the movable scroll 324 orbits (revolves) around the rotational axis AX and the refrigerant in the compression chamber is compressed. The compressed refrigerant is discharged (output, supplied) from the compression mechanism 320 to the discharge port 305 via the fluid communication path 304.

### A2. Configuration of Motor 310

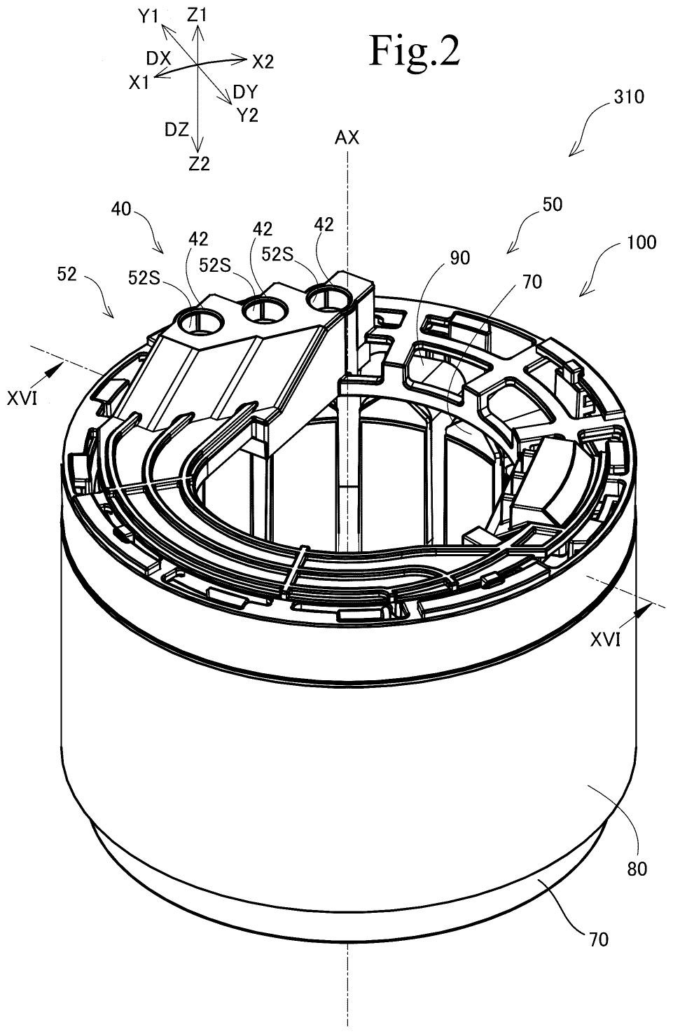

FIG. 2 is an explanatory view showing the configuration of the motor 310 according to the first embodiment of the present disclosure. The motor 310 includes the stator 100, the rotor 200, and the connection member 52. Note that, for ease of understanding of the technology, the rotor 200, which is shown in FIG. 1, is not shown in the other drawings, including FIG. 2.

Several of the drawings, including FIG. 2, schematically show three directions used in the present disclosure. In these drawings, “axial direction DZ” refers to the axial direction of the rotational axis AX of the rotor 200, i.e. a direction that is parallel to or coincides with the rotational axis AX. In the axial direction DZ, the side on which the power supply circuit 340 is arranged with respect to the motor 310 is defined as a “first side Z1 in the axial direction” and the opposite side is defined as a “second side Z2 in the axial direction”. When the motor 310 is arranged in a state in which the rotational axis AX is aligned with the vertical direction, the first side Z1 in the axial direction is also sometimes referred to as the “upper side”, and the second direction Z2 in the axial direction is also sometimes referred to as the “lower side”. “Circumferential direction DX” refers to the circumferential direction around the rotational axis AX. In the circumferential direction DX, when the motor 310 is viewed from the first side Z1 in the axial direction, the counterclockwise direction is defined as a “first side X1 in the circumferential direction” and the clockwise direction is defined as a “second side X2 in the circumferential direction”. “Radial direction(s) DY” pass(es) through (intersect(s)) the rotational axis AX, and is (are) orthogonal to the rotational axis AX. The term “radial direction DY” refers to a radial direction centered on (extending perpendicularly from) the rotational axis AX. In the (each) radial direction DY, the side of the rotational axis AX with respect to a predetermined reference position is defined as an “inner side Y2 in the radial direction” or “radially inward” and the opposite side is defined as an “outer side Y1 in the radial direction” or “radially outward”.

The connection member 52 is disposed on the first side Z1 in the axial direction of the stator 100. Terminal spaces 52S are formed in the connection member 52. One of the conductive terminals 342 and one of the connection terminals 94 are housed in each of the terminal spaces 52S, and the respective conductive terminal 342 and connection terminal 94 are electrically connected to each other. Each terminal space 52S is an example of a “terminal space” according to the present teachings. In the present embodiment, the connection member 52 includes a plurality of the terminal spaces 52S that can respectively hold (accommodate) a plurality of the connection terminals 94 corresponding to a three-phase current, and is configured as a housing that is also referred to as a so-called cluster housing.

As shown in FIG. 2, in the present embodiment, the connection member 52 is connected to a support member 50. As will be further described below, the support member 50 is configured to fix the connection member 52 to the stator 100, or cause the connection member 52 to be stably supported on the stator 100.

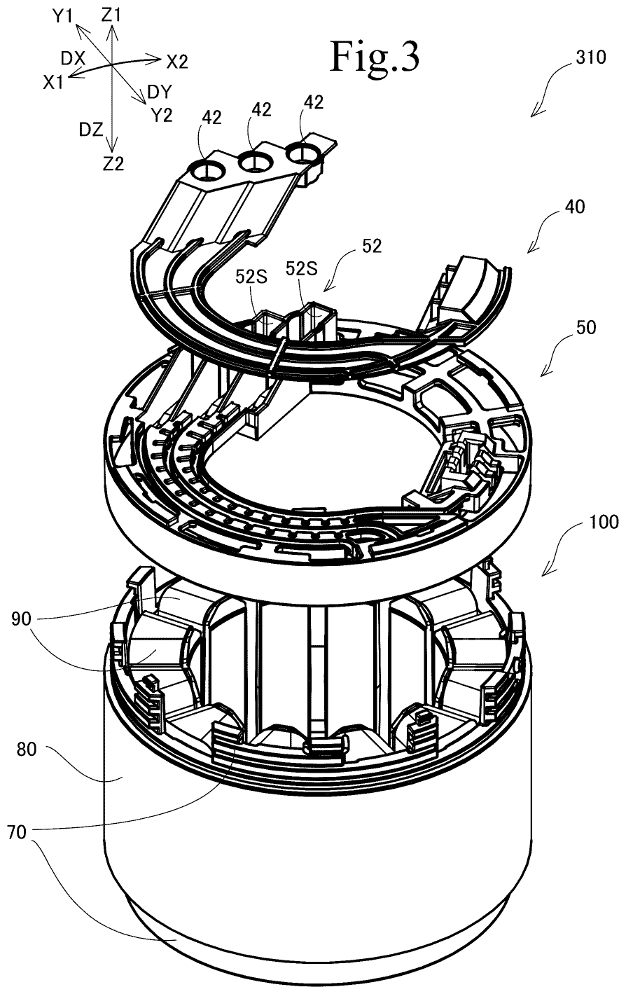

FIG. 3 is an exploded perspective view showing configurations (shapes) of some of the parts of the motor 310. As shown in FIG. 3, in the present embodiment, the motor 310 further includes a cover member 40. As will be further described below, the cover member 40 is disposed on the first side Z1 in the axial direction of the support member 50, protects at least a portion of the support member 50, and protects the connection member 52. Openings 42 are formed in the cover member 40, in order for the conductive terminals 342 to be inserted into the terminal spaces 52S.

### A3. Configuration of Stator 100

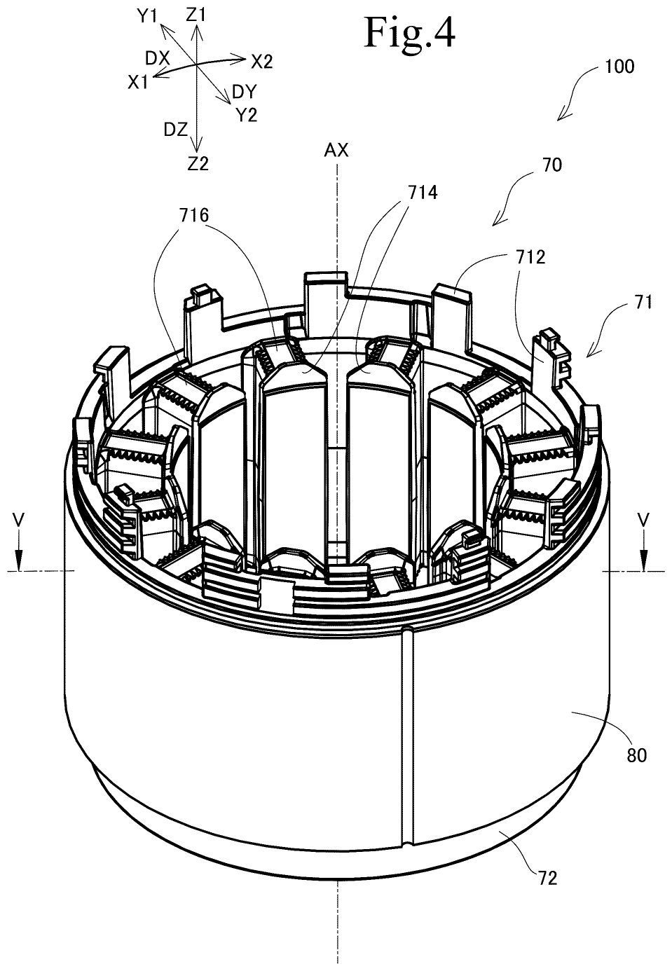

FIG. 4 is an explanatory view showing the configuration of the stator 100. The stator 100 includes a stator core 80, an electrical insulation body 70, and stator windings 90. For ease of understanding the technology, the stator windings 90 are not illustrated in FIG. 4.

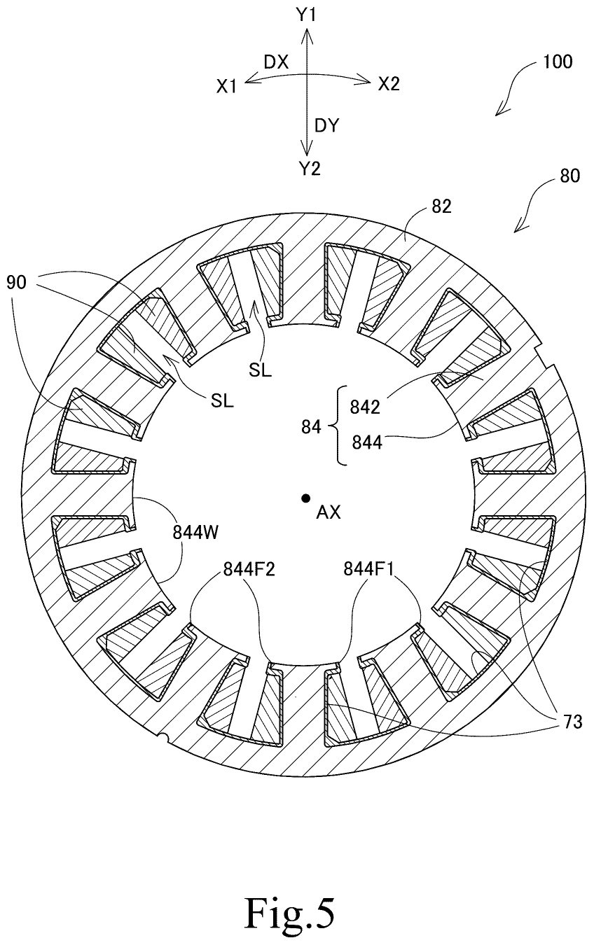

FIG. 5 is a sectional view of cross-section V-V shown in FIG. 4. The stator core 80 is formed by stacking (laminating) a plurality of electrical steel sheets. As shown in FIG. 5, the stator core 80 includes a yoke 82 extending along the circumferential direction DX, and a plurality of teeth 84 extending from an inner peripheral surface of the yoke 82 toward the inner side Y2 in the radial direction.

More specifically, the teeth 84 extend from the inner peripheral surface on the inner side Y2 in the radial direction of the yoke 82 toward the inner side Y2 in the radial direction (i.e. the teeth each extend radially inward). The teeth 84 are spaced apart from each other in the circumferential direction DX, preferably equidistantly. Each of the teeth 84 has a tooth base part 846 and a tooth tip part 844.

Each tooth base part 846 extends toward the inner side Y2 in the radial direction (i.e. extend radially inward) from the inner peripheral surface on the inner side Y2 in the radial direction of the yoke 82 toward the inner side Y2 in the radial direction (i.e. extend radially inward). Each tooth tip part 844 extends continuously from the radially-inward tip end of the tooth base part 842. As shown in FIG. 5, each tooth tip part 844 includes a first flange 844F1 extending from the tip end of the tooth base part 842 toward the first side X1 in the circumferential direction, and a second flange 844F2 extending from the tip end of the tooth base part 842 toward the second side X2 in the circumferential direction. Tooth tip end surfaces 844W, which are formed on the inner side Y2 in the radial direction of the tooth tip parts 844, face the rotor 200 and collectively define a space in which the rotor 200 is rotatably supported.

Slots SL are respectively defined by each pair of teeth 84 that are adjacent to each other in the circumferential direction DX. For example, when coils are wound using a concentrated winding method, stator windings 90 are respectively wound around the teeth 84 via (over) the electrical insulation body 70, by inserting a needle into one of the slots SL from the inner side of the electrical insulation body 70, and moving the inserted needle. In the present embodiment, the stator windings 90 are electrically connected according to a Y connection (also referred to as a “star connection”) type winding. Note that, as methods for winding the stator windings 90 onto the teeth 84, a first method can be used to wind the stator winding 90 onto the teeth 84 in a state in which the electrical insulation body 70 has already been mounted on the stator core 80, or a second method can be used in which the stator windings 90 are first wound onto the electrical insulation body 70 to form the respective coils prior to mounting the electrical insulation body 70 onto the stator core 80.

In the present disclosure, when the stator windings 90 have been respectively wound on (around) the teeth 84, they may be also referred to as “coils”. In addition, segments of the stator windings 90 that respectively connect the coils and the connection terminals 94 may also be referred to as “lead wire parts”. Each lead wire part includes one (a first) end of the stator winding 90 to which one of the connection terminals 94 is attached. A portion of the stator winding 90 configured to function as a neutral point of a Y-connected stator winding 90 is also referred to as a “wire connection part”. The other (second) ends of the stator winding 90 are respectively included in the wire connection parts. In other words, one of the ends (i.e. a (first) portion) of the stator winding 90 that is not wound on a tooth 84 serves as one of the lead wire parts, and the other end (i.e. a (second) portion) of the stator winding 90 that is not wound on the tooth 84 serves as one of the wire connection parts.

### A4. Configuration of Electrical Insulation Body 70

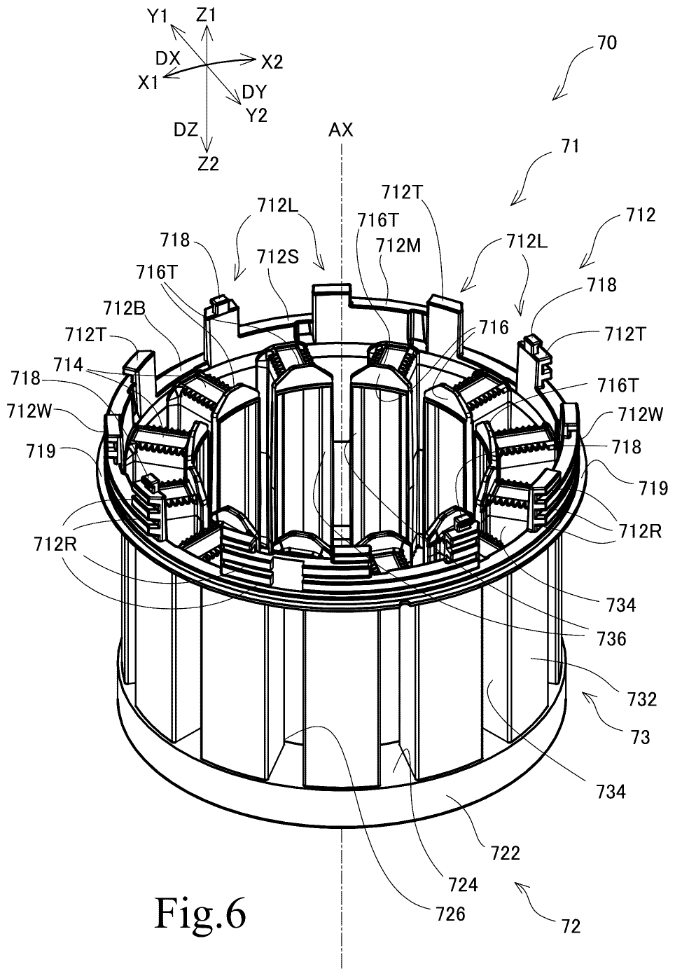

FIG. 6 is a perspective view showing the external configuration of the electrical insulation body 70. In FIG. 6, the stator core 80 has been omitted so that internal structures of the electrical insulation body 70 can be seen. The electrical insulation body 70 comprises (is formed of) a polymer (resin) having electrical insulating properties, such as polyphenylene sulfide (PPS), syndiotactic polystyrene (SPS), polybutylene terephthalate (PBT), a liquid crystal polymer (LCP), or the like. The electrical insulation body 70 is configured to cover the stator core 80, in order to electrically insulate the stator windings (coils) 90 from the stator core 80. The electrical insulation body 70 may also be referred to as a “resin bobbin”. As shown in FIG. 6, the electrical insulation body 70 includes a first insulation part 71, a second insulation part 72, and a third insulation part 73.

In the present embodiment, the electrical insulation body 70 is formed by insert molding. Specifically, a liquid (e.g., molten) resin material is introduced into a die mold, in which the stator core 80 has been placed, to form the electrical insulation body 70 on the stator core 80, and the resin material is allowed to solidify (e.g., harden, cure). As a result, the electrical insulation body 70 is formed in a state in which radially-inner portions of stator core 80 contact radially-outer portions of the electrical insulation body 70, and in which the first insulation part 71, the second insulation part 72, and the third insulation part 73 are integrally formed (i.e. without a seam therebetween).

The second insulation part 72 is arranged on the second side Z2 in the axial direction of the stator core 80. The second insulation part 72 includes a second outer wall part 722, second drum parts 724, and second inner wall parts 726.

The second outer wall part 722 is arranged on an end portion on the second side Z2 in the axial direction of the yoke 82. The second outer wall part 722 is an annular plate-shaped member extending toward the second side Z2 in the axial direction.

The second inner wall parts 726 are arranged on end portions on the second side Z2 in the axial direction of the respective tooth tip parts 844. The second inner wall parts 726 are each (curved) plate-shaped members extending toward the second side Z2 in the axial direction, and are arranged to face (to be concentric with) the second outer wall part 722. Note that the shape of the second inner wall parts 726 is substantially the same as the shape of first inner wall parts 716, which will be described below.

The second drum parts 724 are arranged on end portions on the second side Z2 in the axial direction of the respective tooth base parts 842. Each second drum part 724 extends along the radial direction DY, and is connected to the second outer wall part 722 and one of the second inner wall parts 726. The second drum parts 724 electrically insulate end portions on the second side Z2 in the axial direction of the stator core 80 from the stator windings (coils) 90.

The third insulation part 73 is connected (interposed) between the first insulation part 71 and the second insulation part 72. The third insulation part 73 includes inner wall parts 732, side wall parts 734, and tip end parts 736. The inner wall parts 732 are disposed to face the inner peripheral surface of the yoke 82, and thereby cover the inner peripheral surface of the yoke 82. The side wall parts 734 are disposed to face (and preferably contact) side surfaces on the first side X1 in the circumferential direction of the respective tooth base parts 842 and side surfaces on the second side X2 in the circumferential direction of the respective tooth base parts 842. Thus, the side wall parts 734 cover (and electrically insulate) the side surfaces on the first side X1 in the circumferential direction of the respective tooth base parts 842 and the side surfaces on the second side X2 in the circumferential direction of the respective tooth base parts 842. The tip end parts 736 are disposed to face (and preferably contact) inner peripheral surfaces in the outer side Y1 in the radial direction of the respective first flanges 844F1, and inner peripheral surfaces on the outer side Y1 in the radial direction of the respective second flanges 844F2. Thus, the tip end parts 735 cover (and electrically insulate) the inner peripheral surfaces in the outer side Y1 in the radial direction of the respective first flanges 844F1, and the inner peripheral surfaces on the outer side Y1 in the radial direction of the respective second flanges 844F2.

The first insulation part 71 is disposed on the first side Z1 in the axial direction of the stator core 80. The first insulation part 71 includes a first outer wall part 712, first drum parts 714, and the above-mentioned first inner wall parts 716. That is, the first insulation part 71 includes a number of first drum parts 714 and a number of first inner wall parts 716 corresponding (equal) to the number of the teeth 84.

The first inner wall parts 716 are disposed on end portions on the first side Z1 in the axial direction of the respective tooth tip parts 844. The first inner wall parts 716 are each plate-shaped members extending toward the first side Z1 in the axial direction, and are configured to face (to be concentric with) the first outer wall part 712. The first inner wall parts 716 are an example of an “inner wall part” according to the present teachings.

In the present embodiment, the lengths of the first inner wall parts 716 in the axial direction DZ are all the same as each other. Each point or segment on the end portions on the first side Z1 in the axial direction of the respective first inner wall parts 716 that has a maximum length in the axial direction DZ of the first inner wall part 716 may also be referred to as an “inner apex part 716T”. Note that, if first inner wall parts 716 having differing lengths in the axial direction DZ were to be used in an alternate embodiment of the present teachings, the “inner apex part 716T” refers to the point or segment on each end portion of the respective first inner wall parts 716 that has the maximum length in the axial direction DZ. One or more of the inner apex parts 716T are in contact with a bottom part 528 of the support member 50, which will be further described below.

The first drum parts 714 are disposed at end portions on the first side Z1 in the axial direction of the respective tooth base parts 842. Each first drum part 714 extends along the radial direction DY, and connects the first outer wall part 712 to the respective first inner wall part 716. The first drum parts 714 electrically insulate end portions on the first side Z1 in the axial direction of the stator core 80 from the stator windings (coils) 90. The first drum parts 714 are an example of a “drum part” according to the present teachings.

The first outer wall part 712 is disposed on an end portion on the first side Z1 in the axial direction of the yoke 82. The first outer wall part 712 is an example of an “outer wall part” according to the present teachings. The first outer wall part 712 extends along (around) the circumferential direction DX, and has a substantially circular ring (annular) shape in a plan view. However, the outer wall part 712 may have a shape other than the ring shape, such as having a shape in which one or more portions of the first outer wall part 712 is (are) cut out, or a shape in which the first outer wall part 712 is divided into a plurality of circular-arc shaped segments (i.e. to form a so-called segmented stator).

The first outer wall part 712 includes a plurality of wall portions having differing lengths in the axial direction DZ. Specifically, the first outer wall part 712 includes bottom (base) wall portions 712B, shortest wall portions 712S, medium wall portions 712M, and longest wall portions 712L. Note that, for the portions 712B, 712S, 712M and 712L, the expression “length in the axial direction DZ” refers to (means) the (axial) length from a first end on the second side Z2 in the axial direction to a second end on the first side Z1 in the axial direction while the first outer wall part 712 is disposed on the motor 310. The axial ends of the longest wall portions 712L having the longest length in the axial direction DZ of the first outer wall part 712 are also each referred to as an “outer apex part 712T”. In the present disclosure, the expression “length in the axial direction DZ” is also sometimes referred to as a “height”.

Each longest wall portion 712L is an axially-extending segment of the first outer wall part 712 having the longest length in the axial direction DZ from among the portions 712S, 712M and 712L. Note that the length in the axial direction DZ of the longest wall parts 712L is longer than the length in the axial direction DZ of the inner apex parts 716T. In the present embodiment, the outer apex parts 712T are end portions (points or segments) on the first side Z1 in the axial direction of the longest wall parts 712L.

Each shortest wall portion 712S is an axially-extending segment of the first outer wall part 712 having the shortest length in the axial direction DZ from among the portions 712S, 712M and 712L. However, the length in the axial direction DZ of the shortest wall portions 712S is equal to or greater than the (maximum) length (i.e. from the base to the inner apex part 716T) in the axial direction DZ of the first inner wall parts 716.

Each bottom wall portion 712B is a segment of the first outer wall part 712 having a length in the axial direction DZ that is less than the length in the axial direction DZ of the first inner wall parts 716. In some embodiments of the present teachings, the length in the axial direction DZ of all of the bottom wall portions 712B are equal. However, in other embodiments of the present teachings, bottom wall portions 712B having different heights may be formed, as long as all the bottom wall portions 712B are lower (i.e. the axial lengths are shorter) than the first inner wall parts 716 in the axial direction DZ.

Each medium wall portion 712M is an axially-extending segment of the first outer wall part 712 having a length in the axial direction DZ that is longer than the axial length of the shortest wall portions 712S, but is shorter than the axial length of the longest wall portions 712L. That is, the medium wall portions 712M have an intermediate height (axial length) between the height (axial length) of the shortest wall portions 712S and the height (axial length) of the longest wall portions 712L. Note that the length in the axial direction DZ of the medium wall portions 712M is also greater than the length in the axial direction DZ of the first inner wall parts 716. In some embodiments of the present teachings, the length in the axial direction DZ of all of the medium wall portions 712M are equal. However, in other embodiments of the present teachings (e.g., as will be further described below in an alternate embodiment), medium wall portions 712M having a plurality of heights may be formed, as long as the medium wall portions 712M are higher (axially longer) than the shortest wall portions 712S and lower (axially shorter) than the longest wall portions 712L.

One or more (parallel) grooves 712R extending along (around) the circumferential direction DX is/are formed (defined) in wall surfaces on the outer side Y1 in the radial direction of the first outer wall part 712, i.e., in radially-outer peripheral surfaces 712W of the first outer wall part 712. The width and depth of the groove(s) 712R respectively correspond to the width and height of a single lead wire part that is attached to one (first) end of the stator windings 90. The (each) groove 712R accommodates (holds) (one of) the single lead wire part(s).

The number of grooves 712R is determined based on the wiring path of the lead wire part(s) of the stator 100. In the present embodiment, the maximum number of grooves 712R arrayed in the axial direction DZ is three, and all three grooves 712R are formed in the outer peripheral surfaces 712W of the longest wall portions 712L at equal intervals therebetween and in parallel to each other. Note that the lead wire parts corresponding to each of a U phase, a V phase, and a W phase are respectively accommodated (held) in these three grooves 712R. Note that two of the grooves 712R are formed in the outer peripheral surfaces 712W of the medium wall portions 712M and only one of the grooves 712R is formed in the outer peripheral surfaces 712W of the shortest wall portions 712S.

Each groove 712R both holds and electrically insulates the lead wire part disposed in the (respective) groove 712R from other conductive components, including the lead wire part(s) disposed in an adjacent one(s) of the grooves 712R, a coil, and the like. The depth of each groove 712R in the radial direction DY is preferably sufficiently deep to entirely accommodate the respective lead wire parts, in order to optimize electrical insulating properties. Further, the height (length, distance) between the adjacent grooves 712R in the axial direction DZ is preferably sufficiently long to fully insulate axially adjacent lead wire parts from each other, thereby further improving the electrical insulating properties. By (deeply) disposing the lead wire part(s) in the groove(s) 712R, it is possible, for example, to omit an insulating material that would (otherwise) cover the radially outer surface the lead wire part(s) to provide electrical insulation with respect to other conductive components, such as using an insulation tube known in the related art or the like to radially encircle the radially-outer side of the lead wire parts with insulating material. Thus, it is possible to electrically insulate the lead wire part(s) using a simpler configuration than in the related art. Further, it is possible to reduce the number of components (part count) of the stator 100. In addition, by omitting the radially-outer insulating material, it is possible to expand a region (i.e. a region radially inward of the first outer wall part 712) in the first insulation part 71, in which the connection member 52 and the support member 50 can be disposed, as will be further explained below.

One (the first) end of one of the stator windings 90 is guided from the proximal coil radially outward of the first outer wall part 712, and is accommodated in one of the grooves 712R define in the outer peripheral surfaces 712W. This one (first) end of the stator winding 90 disposed in the groove 712R is a component of the “lead wire part”, as was explained above. Portions of the stator winding(s) 90 (which are not a portion of the coil(s)) is (are) disposed in the groove(s) 712R in accordance with the wiring path that is determined in advance. The lead wire part(s) disposed in the groove(s) 712R is (are) guided toward the first side Z1 in the axial direction of the support member 50, as will be described below.

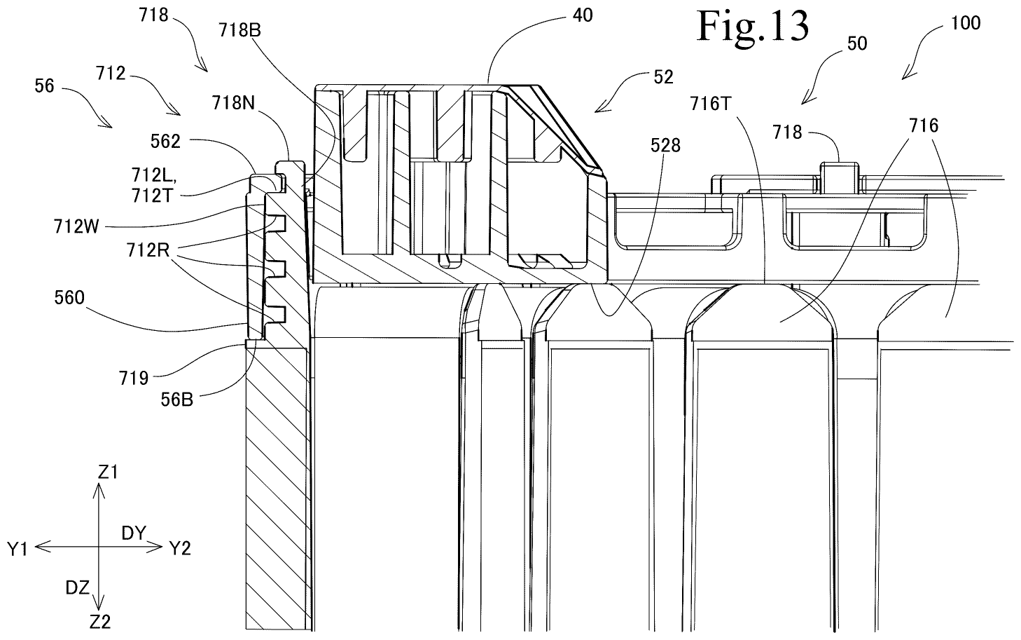

As described above, in the motor 310 according to the present embodiment, by disposing portions of the stator winding(s) 90 in the groove(s) 712R formed in the outer peripheral surfaces 712W of the first outer wall part 712, portions of the lead wire part(s) can be disposed further toward the outer side Y1 in the radial direction than (i.e. radially outward of) the radially-inner circumferential surface of the first outer wall part 712, i.e. portions of the lead wire part(s) is (are) disposed (located) radially outward of the radially innermost surface(s) of the first outer wall part 712. Thus, the region, in which some of the members, such as the connection member 52 and the support member 50, can be disposed, can be expanded in the direction radially inward of the first outer wall part 712. Owing to this design, the bottom part 528 of the connection member 52 can easily be disposed in a region, for example, that is located further toward the second side Z2 in the axial direction than the outer apex parts 712T (i.e. axially below (towards the axial second side Z2 of) the outer apex parts 712T), as can be seen, e.g., in FIG. 13.

As shown in FIG. 6, in the present embodiment, the first insulation part 71 further includes a flange 719. The flange 719 is a plate-shaped member extending from an end portion on the second side Z2 in the axial direction of the first outer wall part 712 toward the outer side Y1 in the radial direction, i.e. the annular flange 719 extends radially outward from the radially outer surface of the first outer wall part 712. In other words, the flange 719 is formed further toward the outer side Y1 in the radial direction than (radially outward of) the outer peripheral surfaces 712W of the first outer wall part 712. The flange 719 is disposed so as to face an (a radially outward) end portion of the yoke 82 on the outer side Y1 in the radial direction. The flange 719 supports an (annular) outer peripheral wall part 56 included in the support member 50, as will be further described below.

In the present embodiment, the flange 719 has a substantially circular ring shape extending in the circumferential direction DX, and is formed around the entire circumference of an outer peripheral edge of the first insulation part 71. However, the flange 719 may have a shape other than the ring shape. For example, one or more portions of the flange 719 may be cut out. In such a modified example, a plurality of circular-arc shaped (discrete, spaced apart) flanges 719 may be formed on the outer peripheral surface of the first insulation part 71.

In the present embodiment, the first insulation part 71 further includes engagement parts 718. As will be further described below, the engagement parts 718 are configured to engage the support member 50 with the first insulation part 71. The engagement parts 718 are an example of a “second engagement part” according to the present teachings. In the present embodiment, the engagement parts 718 function to engage (retain, hold) the support member 50 with (on) the first insulation part 71. Note that the engagement parts 718 may be configured to engage the connection member 52 with the first insulation part 71, instead of or in addition to the support member 50.

As shown in FIG. 6, in the present embodiment, the engagement parts 718 are formed at (on) some (but not all) of the outer apex parts 712T of the first outer wall part 712. In the example shown in FIG. 6, the engagement parts 718 are formed on four of the outer apex parts 712T at locations that are disposed at substantially equal intervals from each other (i.e. at approximately 90° intervals). However, the configuration of the engagement parts 718 is not limited to these four engagement parts 718, and the number of engagement parts 718 may be any desired number, such as one, or two or more.

### A5. Configuration of Connection Member 52 and Support Member 50

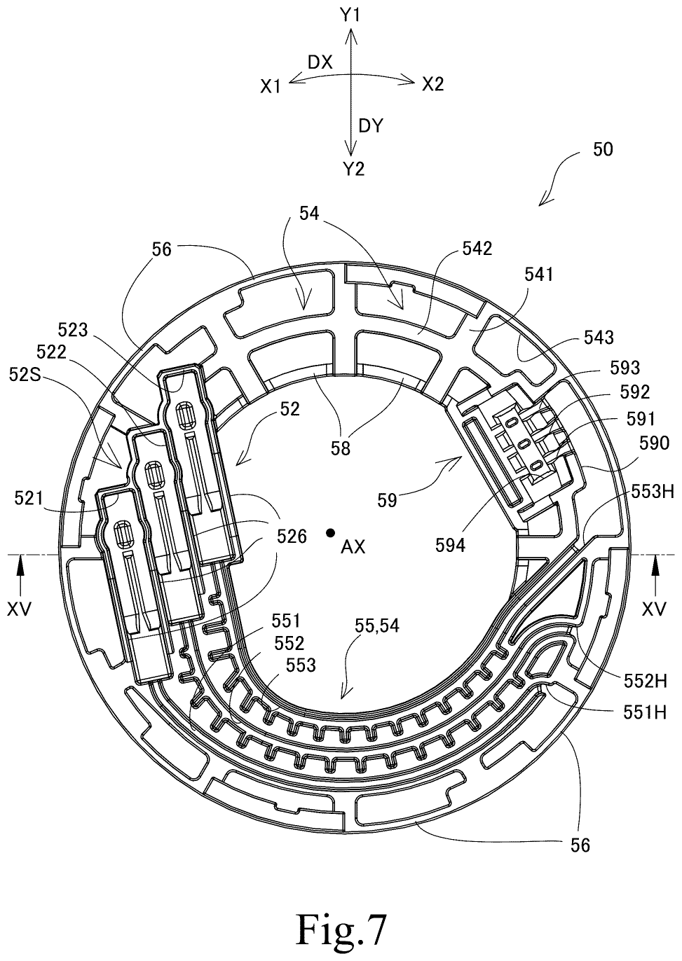

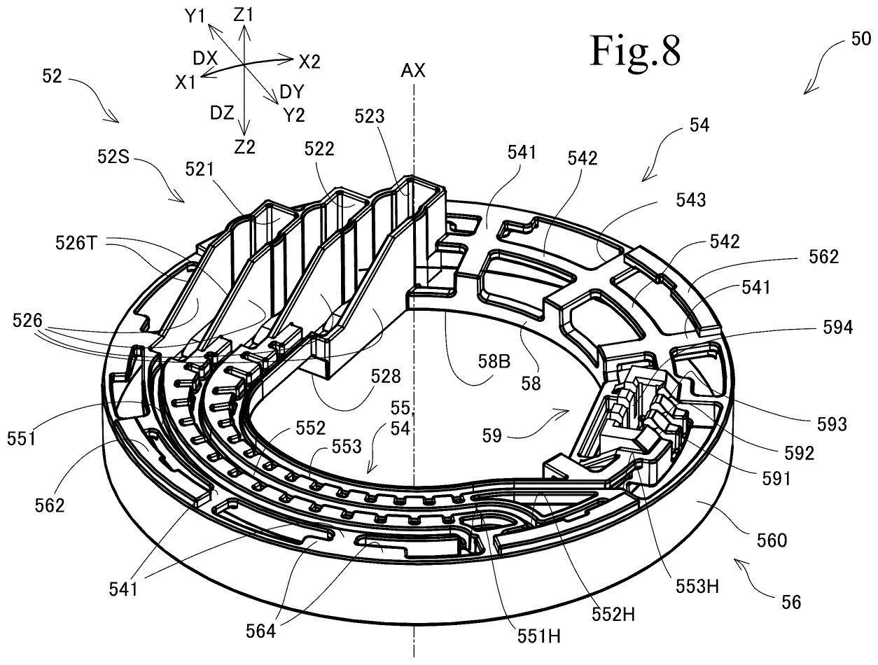

The configuration of the connection member 52 and the support member 50 included in the motor 310 according to the present embodiment will now be described with reference to FIG. 7 to FIG. 16. FIG. 7 is a plan view showing the configuration of the connection member 52 and the support member 50. FIG. 8 is a perspective view showing the configuration of the connection member 52 and the support member 50. The connection member 52 and the support member 50 can be formed, e.g., from the same (preferably polymer) material as the electrical insulation body 70, or from one or more different (preferably polymer) materials.

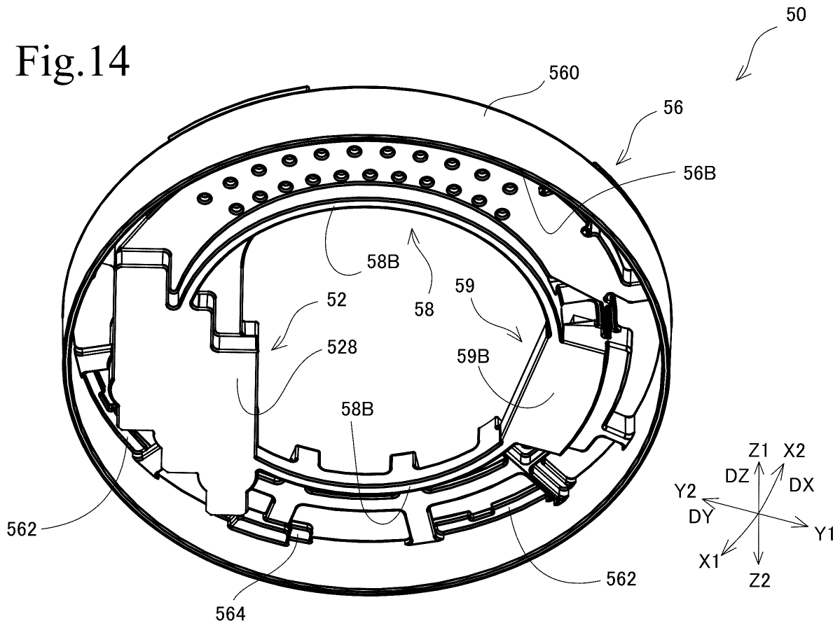

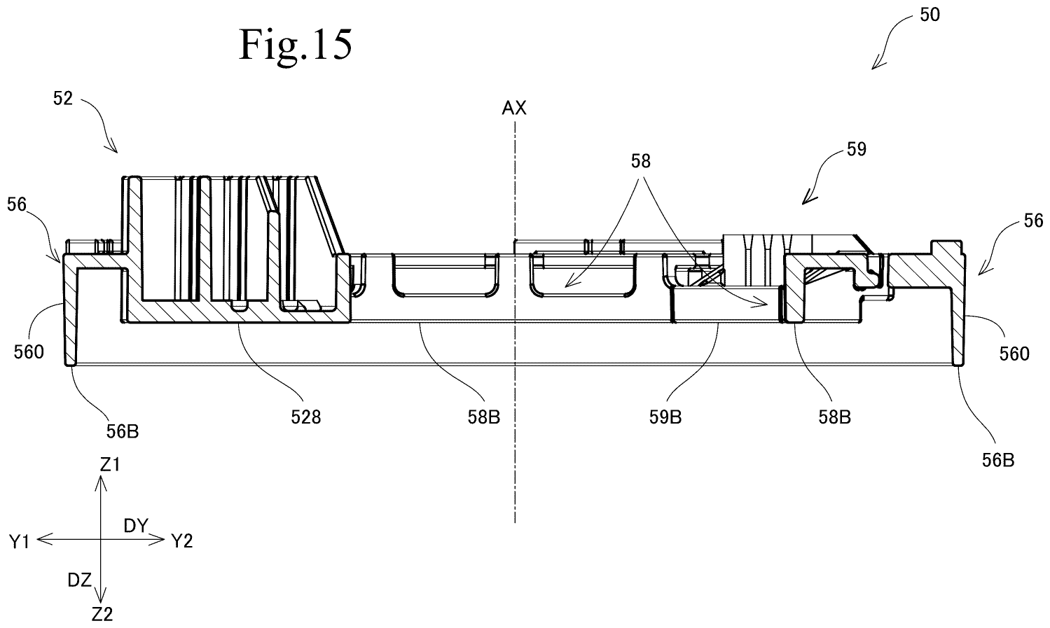

Referring to FIG. 7 and FIG. 8, the connection member 52 includes the bottom part 528 (see also FIGS. 14 and 15), and a plurality of side wall parts 526 extending from the bottom part 528 toward the first side Z1 in the axial direction. The bottom part 528 is a wall surface on the second side Z2 in the axial direction of the connection member 52. Inclined parts 526T are formed on the first side Z1 in the axial direction of the side wall parts 526 and are inclined at a prescribed angle (see below) with respect (relative) to the bottom part 528.

The terminal spaces 52S (see also FIG. 3) are defined by the plurality of side wall parts 526 and the bottom part 528. In the present embodiment, there are three terminal spaces 521, 522, and 523 respectively corresponding to a U-phase lead wire part 91p, a V-phase lead wire part 92p, and a W-phase lead wire part 93p, as will be further explained below.

As shown in FIG. 7 and FIG. 8, the support member 50 is a structural body connected to the connection member 52. As will be further described below, the support member 50 is configured to fix the connection member 52 to the stator 100, or to cause the connection member 52 to be stably supported on the stator 100, by coming into contact with a plurality of locations on the stator 100 (more specifically, on the first insulation part 71). In the present embodiment, the support member 50 is integrally formed with the connection member 52 by resin molding (injection molding or insert molding) or the like. However, it is noted that, in alternate embodiments of the present teachings, the support member 50 and the connection member 52 may be formed separately from each other and subsequently connected by any desired method, such as welding (fusing), adhesion, bonding, or the like. The support member 50 includes a bridge member 54, a lead wire compartment 55, the outer peripheral wall part 56, an inner peripheral wall part 58, and a wire connection terminal compartment 59.

The bridge member 54 connects the connection member 52 to at least one of the structural members of the support member 50. In the present embodiment, the bridge member 54 connects the connection member 52 to the lead wire compartment 55, the outer peripheral wall part 56, the inner peripheral wall part 58, and the wire connection terminal compartment 59. By connecting the members of the support member 50 in contact with the stator 100 to the connection member 52 via the bridge member 54, it is possible to use the support member 50 to fix the connection member 52 to the stator 100 or to cause the connection member 52 to be stably supported on the stator 100. However, it is noted that, in an alternate embodiment in which the connection member 52 is directly supported by (on) the stator 100, the bridge member 54 may be omitted.

In the present embodiment, the bridge member 54 includes first bridge members 541 extending in the radial direction DY, and a second bridge member 542 extending in the circumferential direction DX. The bridge member 54 is formed in a lattice shape and includes openings 543 formed by the first bridge members 541 and the second bridge member 542. Owing to the openings 543, the amount (rate) of refrigerant that can flow through the motor 310 can be increased. Further, the amount of material needed to form the support member 50 can be reduced, thereby reducing material costs and weight without sacrificing performance or structural stability.

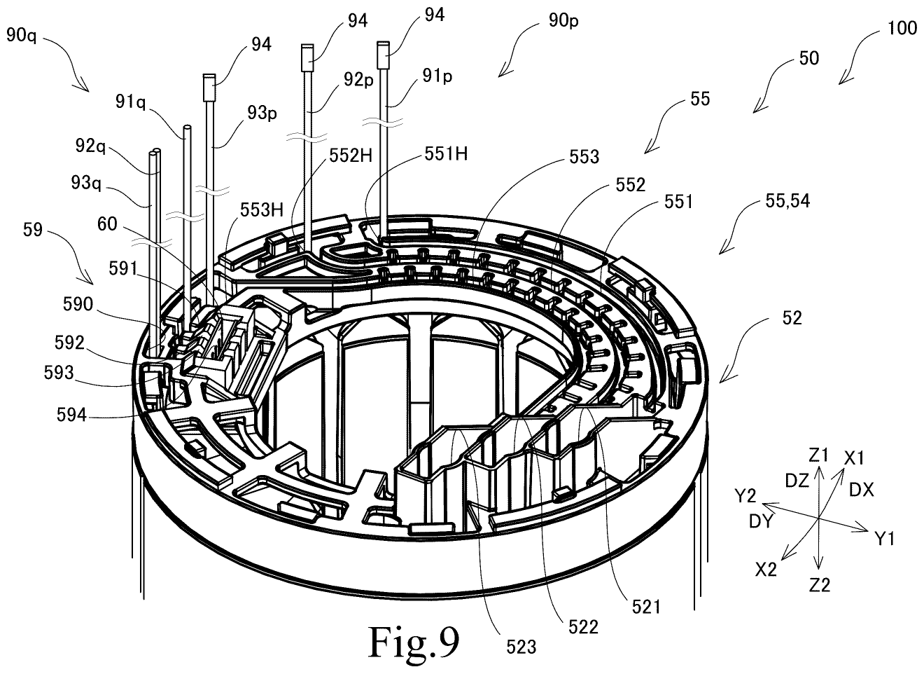

The configuration of the lead wire compartment 55 and the wire connection terminal compartment 59 will be described with reference to FIG. 9 to FIG. 11, in addition to FIG. 7 and FIG. 8. FIG. 9 is an explanatory view showing a method (scheme) for arranging the lead wire parts 91p, 92p, 93p and the wire connection parts 91q, 92q, 93q of the stator windings 90. Here, it is noted that the lead wire parts 91p, 92p, 93p are respectively disposed at one (a first) end of the stator windings 90 and the wire connection parts 91q, 92q, 93q are respectively disposed at the other (a second) end of the stator windings 90, as was explained above.

As shown in FIG. 7 to FIG. 9, the lead wire compartment 55 houses (accommodates, holds) the lead wire parts 91p, 92p, 93p pulled (extending) out from the stator 100. For example, the lead wire compartment 55 is configured to reduce the likelihood of or even prevent an electrical short circuit between the lead wire parts 91p, 92p, 93p and other members, such as the coils. Further, because the connection member 52 is connected to the outer peripheral wall part 56, the inner peripheral wall part 58, and the wire connection terminal compartment 59 of the support member 50, the lead wire compartment 55 supports the function of the bridge member 54.

The U-phase lead wire part 91p, the V-phase lead wire part 92p, and the W-phase lead wire part 93p are illustrated in FIG. 9. The connection terminals 94 that are respectively connectable to the conductive terminals 342 (see FIG. 1) of the power supply circuit 340 are attached to tip ends of the lead wire parts 91p, 92p, and 93p. In the following description, when no particular distinction is made between the lead wire parts 91p, 92p, and 93p, they may be collectively referred to as a “lead wire part 90p” or as “lead wire parts 90p”.

As shown in FIG. 7 to FIG. 9, the lead wire compartment 55 includes lead-in holes 551H, 552H, and 553H, and grooves (circular arc-shaped channels) 551, 552, and 553. The lead-in holes 551H, 552H, and 553H are through holes (or recesses or grooves) for respectively guiding the lead wire parts 91p, 92p, and 93p from the stator 100 toward the first side Z1 in the axial direction of the support member 50. The lead-in holes 551H, 552H, and 553H respectively communicate with the terminal spaces 521, 522, and 523 of the connection member 52 via the grooves 551, 552, and 553.

Portions of the lead wire parts 91p, 92p, and 93p, which have been guided toward the first side Z1 in the axial direction of the support member 50 via the lead-in holes 551H, 552H, and 553H, are respectively accommodated (held) in the grooves 551, 552, and 553. The portions of the lead wire parts 91p, 92p, and 93p respectively disposed in the grooves 551, 552, and 553 of the lead wire compartment 55 are electrically insulated from other conductive components, including the lead wire parts disposed in the adjacent grooves, the coils, and the like. The length of the lead wire compartment 55 in the axial direction DZ (i.e., the axial depth of the grooves 551, 552, and 553) is preferably relatively deep, in order to improve the electrical insulating properties of the lead wire compartment 55. Further, the distance in the radial direction DY between radially adjacent grooves is also preferably relatively long, in order to improve the electrical insulating properties. Because portions of the lead wire parts 91p, 92p, and 93p are respectively (deeply) disposed in the grooves 551, 552, and 553 of the lead wire compartment 55, it is possible to omit an insulating material to cover the lead wire parts 91p, 92p, and 93p that would otherwise provide electrical insulation with respect to other conductive components. Thus, it is possible to electrically insulate the lead wire parts 91p, 92p, 93p using a simpler configuration than in the related art. The connection terminals 94 attached to the tip ends of the lead wire parts 91p, 92p, and 93p are respectively disposed in the terminal spaces 521, 522, and 523.

As shown in FIG. 9, the wire connection terminal compartment 59 includes a lead-in hole 590, grooves 591, 592, and 593, and a recess 594. In FIG. 9, the U-phase wire connection part 91q, the V-phase wire connection part 92q, and the W-phase wire connection part 93q, which are the other (second) ends of the stator windings 90, are illustrated. The wire connection parts 91q, 92q, and 93q are electrically connected in order to form the neutral point (or central point) of the wye-connection (also known as a Y-connection or star-connection). The wire connection for forming the neutral point is also referred to as a “neutral point connection” or “being connected as the neutral point”. In the following description, when no particular distinction is made between the wire connection parts 91q, 92q, and 93q, they may be collectively referred to as a “wire connection part 90q” or as “wire connection parts 90q”.

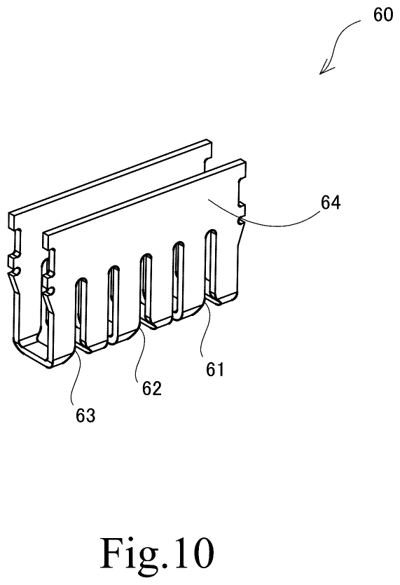

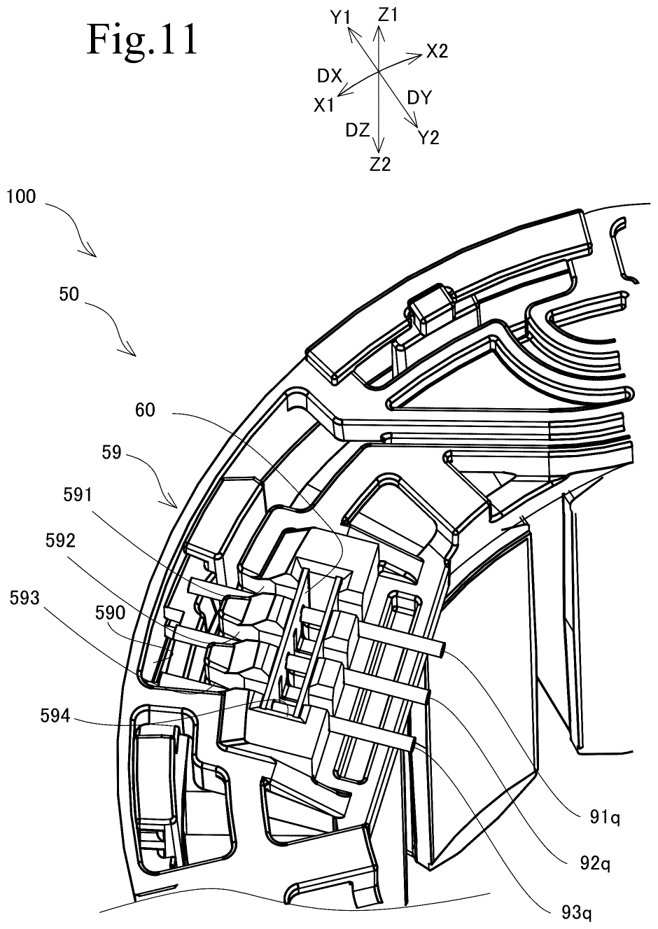

The lead-in hole 590 (see also FIG. 11) is a through hole for guiding the wire connection parts 91q, 92q, and 93q from the stator 100 toward the first side Z1 in the axial direction of the support member 50. The lead-in hole 590 communicates with the grooves 591, 592, and 593. Portions of the wire connection parts 91q, 92q, and 93q, which have been guided toward the first side Z1 in the axial direction of the support member 50 via the lead-in hole 590, are respectively accommodated (held) in the grooves 591, 592, and 593 and pass through the recess 594. The wire connection parts 91q, 92q, and 93q disposed in the recess 594 are connected as the neutral point by a wire connection terminal 60 (see also FIG. 10), as will be further described below.

The grooves 591, 592, and 593 electrically insulate the wire connection parts 91q, 92q, and 93q respectively disposed in the grooves 591, 592, and 593 from other conductive components, including the lead wire parts disposed in the other grooves, the coils, and the like. The length in the axial direction DZ of the grooves 591, 592, and 593 (i.e., the axial depth of the grooves 591, 592, and 593) is preferably relatively deep, in order to improve electrical insulating properties.

Further, the distance between the adjacent grooves 591, 592, and 593 in the circumferential direction DX is preferably relatively long, in order to improve the electrical insulating properties. Because the wire connection parts 91q, 92q, and 93q are respectively disposed in the grooves 591, 592, and 593, it is possible to omit an insulating material to cover the wire connection parts 91q, 92q, and 93q that would otherwise provide electrical insulation with respect to other conductive components. Thus, it is possible to electrically insulate the wire connection parts 91q, 92q, and 93q in a satisfactory manner using a simpler configuration than in the related art.

FIG. 10 is a perspective view showing the configuration of the wire connection terminal 60. The wire connection terminal 60 may also be referred to as a MAG-MATE terminal. The wire connection terminal 60 includes a main body 64, and terminal insertion parts 61, 62, and 63. The terminal insertion parts 61, 62, and 63 are slits formed in the main body 64, and the wire connection parts 91q, 92q, and 93q are respectively inserted through the terminal insertion parts 61, 62, and 63. The wire connection terminal 60 is formed (composed) of an electrically conductive metal material.

FIG. 11 is an explanatory view showing the wire connection parts 91q, 92q, and 93q that are connected as the neutral point using the wire connection terminal 60. As shown in FIG. 11, the wire connection terminal 60 is inserted into the recess 594 in a state in which the wire connection parts 91q, 92q, and 93q are respectively disposed in the grooves 591, 592, and 593 and the recess 594. When the wire connection terminal 60 is inserted into the recess 594, the wire connection parts 91q, 92q, and 93q are respectively inserted into the terminal insertion parts 61, 62, and 63. The wire connection terminal 60 is deformed by pressure when it is inserted into the recess 594, and thereby penetrates a film (sheath, coating), such as an insulating material, formed (provided) on each of the surfaces of the wire connection parts 91q, 92q, and 93q. As a result, the wire connection parts 91q, 92q, and 93q become electrically connected to each other via the wire connection terminal 60, and are connected as the neutral point. Thus, by using the wire connection terminal 60, it is possible to form the neutral point using a relatively simple method. Further, by disposing the neutral point in the wire connection terminal compartment 59 of the support member 50, the wire connection parts 91q, 92q, and 93q can be fixed to the stator 100 or disposed on the stator 100 in a stable state (manner).

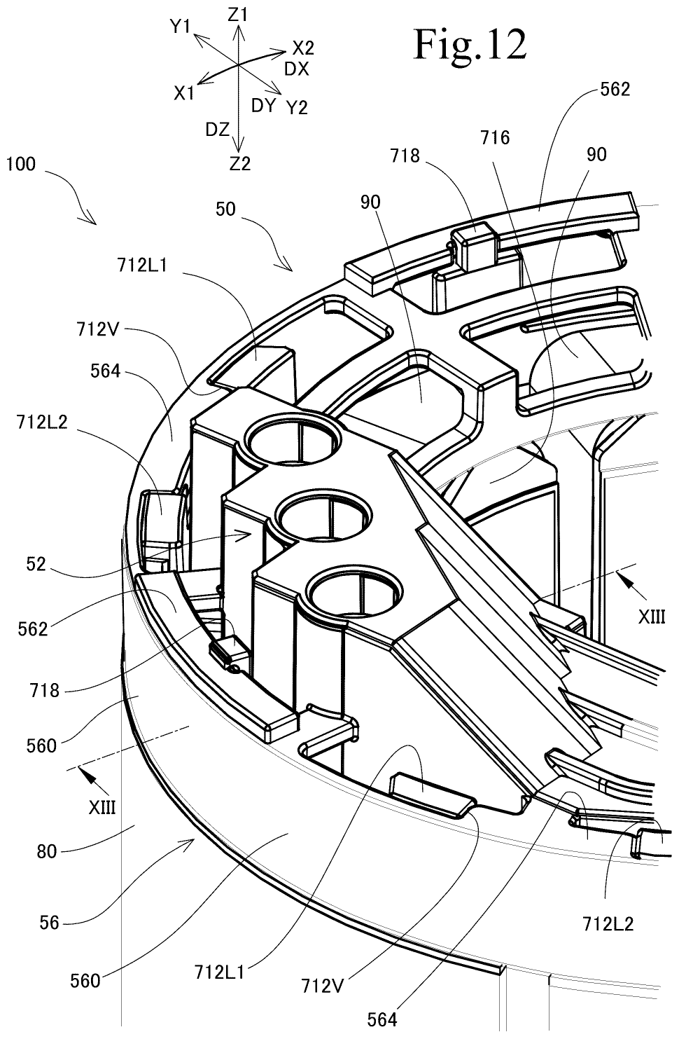

The specific configuration of the outer peripheral wall part 56 will now be described with reference to FIG. 12 to FIG. 14, in addition to FIG. 8. FIG. 12 is a perspective view showing the configuration of the outer peripheral wall part 56. As shown in FIGS. 12-14, the outer peripheral wall part 56 includes a main body 560, outer peripheral wall flanges 562, and an outer wall projection 564.

As shown in FIG. 8, the main body 560 is a plate-shaped (circular cylindrical-shaped, annular) member extending in the circumferential direction DX. The circumferential surface direction of the main body 560 is arranged to be at least substantially parallel (or parallel) to the axial direction DZ. Further, the main body 560 is disposed around (along) the entire circumference of a (radially outer) peripheral edge on the outer side Y1 in the radial direction of the support member 50. In other words, in the present embodiment, the main body 560 has a substantially circular ring shape in a cross-section perpendicular to the axial direction. However, the main body 560 need not necessarily have the ring shape. For example, one or more portions of the main body 560 may be cut out. In such a modified example, a plurality of the main bodies 560 may be disposed at a plurality of locations at (along) the peripheral edge on the outer side Y1 in the radial direction of the support member 50.

The main body 560 is connected to the connection member 52 via the bridge member 54. However, in an alternate embodiment, the main body 560 may instead be directly connected to the connection member 52. Consequently, the expression “is connected to the connection member 52” can include a state in which a member included in the support member 50 is directly connected to the connection member 52, and a state in which a member included in the support member 50 is indirectly connected to the connection member 52 via one or more other members included in the support member 50, such as the bridge member 54.

The main body 560 is disposed further toward the outer side Y1 in the radial direction than (radially outward of) the first outer wall part 712 of the first insulation part 71; i.e., the main body 560 is disposed radially outward of the first outer wall part 712. An inner peripheral surface on the inner side Y2 in the radial direction of the main body 560 (i.e., a radially inner surface of the main body 560) faces (opposes) the outer peripheral surfaces 712W of the first outer wall part 712 (as can be seen, e.g., in FIG. 13). In other words, the main body 560 is disposed so as to cover (radially surround) the outer peripheral surfaces 712W. By utilizing this type of configuration, the lead wire parts 90p disposed in the grooves 712R of the outer peripheral surface 712W can be reliably electrically insulated from other conductive components. Specifically, it is possible to reduce the likelihood of or even prevent the occurrence of an electrical short circuit or a flashover between the lead wire parts 90p and conductive components included in the compressor 300, such as wall surfaces of the motor chamber 303, or other conductive components included in the motor 310.

As shown in FIG. 12, the outer peripheral wall flanges 562 are continuous with an end surface on the first side Z1 in the axial direction of the main body 560. The outer peripheral wall flanges 562 protrude from the main body 560 toward the inner side Y2 in the radial direction (radially inward), and extend along the circumferential direction DX. The outer peripheral wall flanges 562 are configured to protrude further toward the first side Z1 in the axial direction (radially inward) than other portions of the main body 560.

FIG. 13 is a sectional view of cross-section XIII-XIII shown in FIG. 12. In the present embodiment, the outer peripheral wall part 56 is configured to be in contact with an end portion on the first side Z1 in the axial direction of the first insulation part 71. More specifically, the outer peripheral wall part 56 is configured to be in contact, inter alia, both with the outer apex parts 712T of the longest wall portions 712L (on the first side Z1 in the axial direction) as well as with the (annular) flange 719 of the first insulation part 71 (on the second side Z2 in the axial direction).

That is, as shown in FIG. 13, an (annular) end portion (end surface) 56B (see also FIG. 14) of the outer peripheral wall part 56 on the second side Z2 in the axial direction of the main body 560 is configured to be in contact with an annular surface on the first side Z1 in the axial direction of the (annular) flange 719. By utilizing this type of configuration, the first insulation part 71 can support the peripheral edge part (annular end portion/surface 56B) on the outer side Y1 in the radial direction of the support member 50. Thus, movement of the support member 50 in the axial direction DZ is restricted (blocked), and the connection member 52 and the support member 50 can be disposed on the stator 100 in a stable state (manner).

As also shown in FIG. 13, the outer peripheral wall flanges 562 extend toward the inner side Y2 in the radial direction (radially inward) and also extend further toward the first side Z1 in the axial direction than the outer apex parts 712T. A wall surface on the second side Z2 in the axial direction of the outer peripheral wall flanges 562 is configured to be in contact with the respective outer apex parts 712T of the longest wall portions 712L. By utilizing this type of configuration, the first insulation part 71 can support the peripheral edge part (annular end portion/surface 56B) on the outer side Y1 in the radial direction of the support member 50. Thus, movement of the support member 50 in the axial direction DZ is restricted (blocked), and the connection member 52 and the support member 50 can be disposed on the stator 100 in the stable state (manner).

Still referring to FIG. 13, the outer peripheral wall flanges 562 are also configured to be respectively engaged with the engagement parts 718 of the first insulation part 71. Thus, the outer peripheral wall flanges 562 are an example of a “first engagement part” according to the present teachings. The engagement parts 718 have a so-called snap fit structure. More specifically, each engagement part 718 includes a base part 718B and a claw (hook) part 718N.

Each base part 718B protrudes from the respective outer apex part 712T toward the first side Z1 in the axial direction. Each claw part 718N protrudes from a tip end of the base part 718B toward the outer side Y1 in the radial direction (radially outward). When mounting the support member 50 on the first insulation part 71, the outer peripheral wall flanges 562 are moved toward the respective outer apex parts 712T such that the outer peripheral wall flanges 562 respectively come into contact with the base parts 718B, whereby the base parts 718B elastically deform toward the inner side Y2 in the radial direction (radially inward). When the outer peripheral wall flanges 562 have been moved to a position where they respectively contact the outer apex parts 712T, the base parts 718 elastically return to their original positions, and each of the outer peripheral wall flanges 562 is respectively engaged between one of the outer apex parts 712T and one of the claw parts 718N. In this way, due to the snap-fit engagement between the outer peripheral wall flanges 562 and the engagement parts 718, movement of the main body 560 relative to the first insulation part 71 in the axial direction DZ and movement of the main body 560 in the radial direction DY are restricted (blocked), such that the connection member 52 and the support member 50 can be disposed (held) on the stator 100 in the stable state (manner).

Referring back to FIG. 12, the outer wall projections 564 protrude from an end portion on the first side Z1 in the axial direction of the main body 560 toward the inner side Y2 in the radial direction (radially inward). The outer wall projections 564 extend along the circumferential direction DX on a wall surface on the inner side Y2 in the radial direction of the main body 560. The outer wall projections 564 are configured (located) to be in the same plane as an end surface on the first side Z1 in the axial direction of the main body 560. Note that the end surface on the first side Z1 in the axial direction of the main body 560 is configured to be in the same plane as the outer apex parts 712T of the longest wall portions 712L.

From among the various portions of the first outer wall part 712, the longest wall portion 712L having the longest axial length is defined as a first longest wall part 712L1, and the longest wall portion 712L adjacent to the first longest wall part 712L1 on the first side X1 in the circumferential direction is defined as a second longest wall part 712L2. Between the first longest wall part 712L1 and the second longest wall part 712L2, an outer wall recess 712V is defined that has a recessed shape toward the second side Z2 in the axial direction. The width of the (each) outer wall projection 564 in the circumferential direction DX corresponds (is equal) to the width of the (each) outer wall recess 712V in the circumferential direction DX. Thus, the outer wall projections 564 are configured to be insertable into (mated or fitted with) the outer wall recesses 712V when the outer wall projections 564 are in contact with the first outer wall part 712. Because the outer wall projections 564 are respectively disposed (fitted) in the outer wall recesses 712V, movement of the support member 50 in the circumferential direction DX is restricted (blocked), such that the connection member 52 and the support member 50 can be disposed on the stator 100 in the stable state (manner).

The specific configuration of the inner peripheral wall part 58 will now be described with reference to FIG. 14 and FIG. 15, in addition to FIG. 8. FIG. 14 is a perspective view showing the configuration (shape) on the second side Z2 in the axial direction of the support member 50. FIG. 15 is a sectional view of cross-section XV-XV shown in FIG. 7.

As shown in FIG. 8 and FIG. 14, the inner peripheral wall part 58 is a generally plate-shaped (circular arc-shaped) member extending in the circumferential direction DX. The circumferential surface direction of the inner peripheral wall part 58 is configured to be at least substantially parallel (or parallel) with the axial direction DZ. The inner peripheral wall part 58 is connected to the connection member 52, the lead wire compartment 55, and the wire connection terminal compartment 59, and is also connected to the outer peripheral wall part 56 via the bridge member 54.

As shown in FIG. 14 and FIG. 15, an end portion (surface) 58B on the second side Z2 in the axial direction of the inner peripheral wall part 58 is configured (arranged) to be in the same plane as the surface of the bottom part 528 of the connection member 52, and also in the same plane as the surface of a bottom part 59B of the wire connection terminal compartment 59. The inner peripheral wall part 58 extends around the entire circumference of a peripheral edge on the inner side Y2 in the radial direction of the support member 50 (i.e. a radially inner edge of the support member 50), except in the regions where the connection member 52 and the wire connection terminal compartment 59 are formed. Note that the inner peripheral wall part 58 need not necessarily be formed over (around) the entire circumference of the peripheral edge on the inner side Y2 in the radial direction, and thus, e.g., one or more portions of the inner peripheral wall part 58 may be cut out. In such an embodiment, a plurality of the inner peripheral wall parts 58 disposed at a plurality of locations on the peripheral edge on the inner side Y2 in the radial direction of the support member 50 may be formed.

In the present embodiment, the end portion (surface) 58B on the second side Z2 in the axial direction of the inner peripheral wall part 58 is disposed (located) to be in contact with the inner apex parts 716T of the first inner wall parts 716, as will be further described below. By utilizing this type of configuration, the first insulation part 71 can support an (a radially inward) inner peripheral edge on the inner side Y2 in the radial direction of the support member 50. Thus, movement of the support member 50 in the axial direction DZ is restricted (blocked) thereby, such that the connection member 52 and the support member 50 can be disposed on the stator 100 in the stable state (manner). Note that the entire end portion (surface) 58B need not necessarily be in contact with the inner apex parts 716T, and instead one or more portions of the end portion (surface) 58B may be in contact with the inner apex parts 716T.

### A6. Arrangement Configuration of Connection Member 52

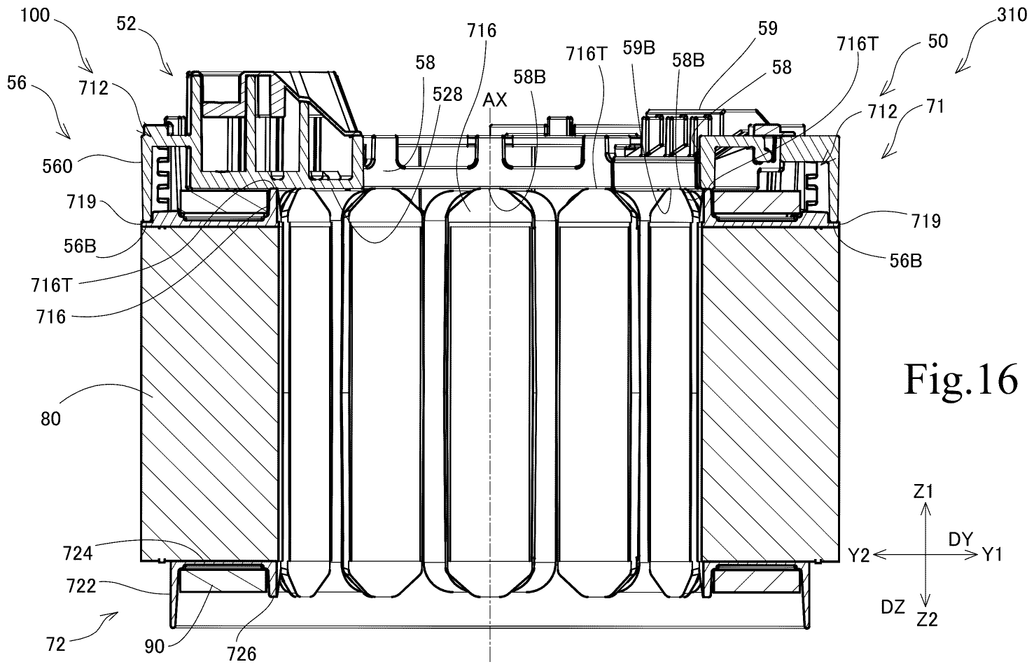

The arrangement configuration of the connection member 52 will now be described with reference to FIG. 16. FIG. 16 is a sectional view of cross-section XVI-XVI shown in FIG. 2. As shown in FIG. 16 (see also FIG. 13), the connection member 52 is configured to be disposed further toward the inner side Y2 in the radial direction than the outer apex parts 712T of the first outer wall part 712; i.e. the connection member 52 is disposed radially inward of the outer apex parts 712T.

Owing to this design, the bottom part 528 of the connection member 52 can be more easily disposed further toward the second side Z2 in the axial direction than the outer apex parts 712T of the first insulation part 71. Note that the expression “further toward the inner side Y2 in the radial direction than the first outer wall part 712” refers to a position further toward the inner side Y2 in the radial direction than (radially inward of) wall surfaces on the inner side Y2 in the radial direction of the first outer wall part 712. In the following description, when the position of the bottom part 528 of the connection member 52 is shown, the wall surface on the second side Z2 in the axial direction of the bottom part 528 may also be simply referred to as the “bottom part 528”, and when the position of the bottom part 59B of the wire connection terminal compartment 59 is shown, the wall surface on the second side Z2 in the axial direction of the bottom part 59B may also be simply referred to as the “bottom part 59B”.

In the present embodiment, instead of disposing the lead wire parts 90p further toward the inner side Y2 in the radial direction than (radially inward of) the first outer wall part 712, the lead wire parts 90p are respectively disposed in the grooves 712R, which are on the outer side Y1 in the radial direction (on the radially outward side) of the first outer wall part 712. Therefore, a region for disposing the connection member 52 can be formed in a region further toward the inner side Y2 in the radial direction than (radially inward of) the first outer wall part 712 and further toward the second side Z2 in the axial direction than the outer apex parts 712T. By configuring the motor 310 in this way, in the region further toward the inner side Y2 in the radial direction than (radially inward of) the first outer wall part 712, the bottom part 528 of the connection member 52 can be easily disposed further toward the second side Z2 in the axial direction than the outer apex parts 712T. Thus, as compared to an embodiment in which the bottom part 528 of the connection member 52 is disposed on the end portion (surface) on the first side Z1 in the axial direction of the first insulation part 71 (i.e. on the uppermost portion of the first insulation part 71 shown in FIG. 16), it is possible to shorten the length of the motor 310 in the axial direction DZ.

In the present embodiment, the bottom part 528 of the connection member 52 is fixed in a state in which the bottom part 528 has been lowered to a position where it contacts one or more of the inner apex parts 716T of the first inner wall parts 716. Thus, as compared to an embodiment in which the bottom part 528 is disposed further toward the first side Z1 in the axial direction than the outer apex parts 712T of the first insulation part 71, it is possible to significantly shorten the length of the motor 310 in the axial direction DZ.

Further, as described above, the bottom part 528 (i.e. the lower surface thereof) of the connection member 52 is configured to be in the same plane as the end portion (surface) 58B on the second side Z2 in the axial direction of the inner peripheral wall part 58, and also in the same plane as the lower surface of the bottom part 59B of the wire connection terminal compartment 59. Thus, by disposing the bottom part 528 of the connection member 52 where it is in contact with one or more the inner apex parts 716T of the first inner wall part 716, the connection member 52 can be supported by the electrical insulation body 70 via a plurality of contact points, including the end portion 58B of the inner peripheral wall part 58 and the bottom part 59B of the wire connection terminal compartment 59. Thus, the connection member 52 can be disposed on the electrical insulation body 70 in a more stable state (manner).

### A7. Configuration of Cover Member 40

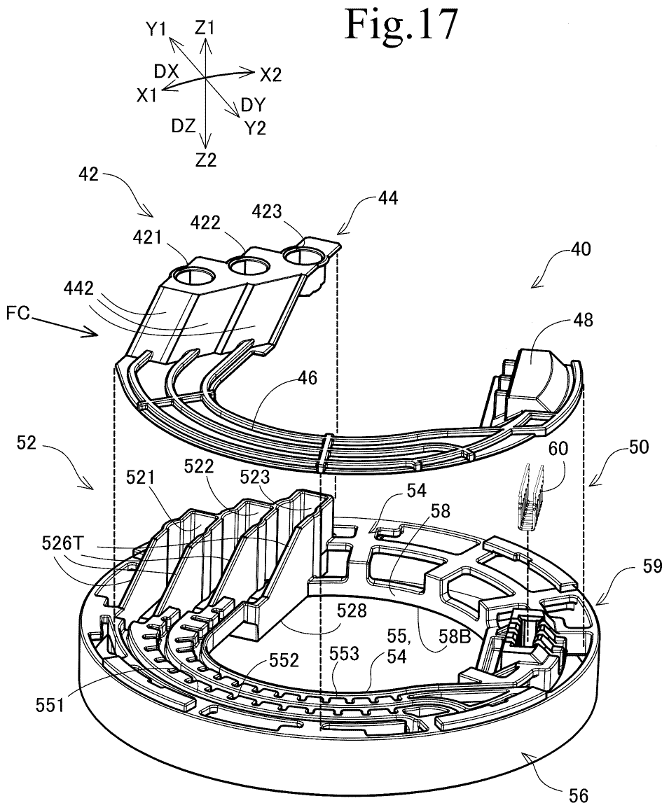

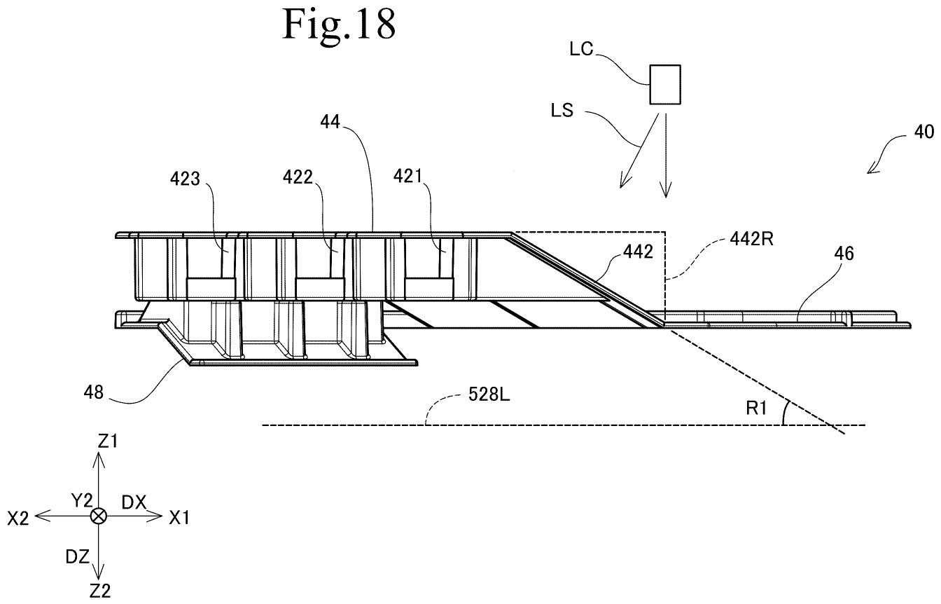

The configuration of the cover member (cover) 40 will now be described with reference to FIG. 17 and FIG. 18. FIG. 17 is a perspective view showing the external configuration (shape) of the cover member 40. The cover member 40 is disposed toward the first side Z1 in the axial direction of at least a portion of the support member 50 and toward the first side Z1 in the axial direction of the connection member 52. The cover member 40 protects the lead wire parts 90p disposed in the terminal spaces 52S of the connection member 52, the lead wire parts 90p disposed in the grooves 551, 552, and 553, and the wire connection parts 90q disposed in the wire connection terminal compartment 59, and the like from the external environment and the like. Further, the cover member 40 electrically insulates the lead wire parts 90p and the wire connection parts 90q from the compressor 300 and other structural (conductive) members of the motor 310.

The cover member 40 is, for example, joined to the connection member 52 and the support member 50 in a state in which the lead wire parts 90p and the wire connection parts 90q are already disposed in the connection member 52. The cover member 40 may be joined to the connection member 52 and the support member 50 by any suitable method such as, e.g., a material bonding method including welding (fusion), adhesion, or the like, or a mechanical connection method including one or more clasps, snap-fit structures or the like. In the present embodiment, the cover member 40 is joined to the connection member 52 and the support member 50 by laser welding (fusing). The cover member 40 includes a first lid part 44, a second lid part 46, and a third lid part 48.

The third lid part 48 is disposed on the first side Z1 in the axial direction of the wire connection terminal compartment 59. The third lid part 48 protects the wire connection parts 91q, 92q, and 93q and the wire connection terminal 60 disposed in the wire connection terminal compartment 59. The third lid part 48 functions as a “wire connection terminal lid part” according to the present teachings.

The second lid part 46 is disposed on the first side Z1 in the axial direction of the lead wire compartment 55. The second lid part 46 is substantially plate-shaped and is disposed facing the lead wire compartment 55. The second lid part 46 protects the lead wire parts 91p, 92p, and 93p housed in the grooves 551, 552, and 553. The second lid part 46 is an example of a “lead wire lid part” according to the present teachings.

The first lid part 44 is disposed on the first side Z1 in the axial direction of the connection member 52. The first lid part 44 is disposed corresponding to the bottom part 528 of the connection member 52, and covers the first side Z1 in the axial direction of the terminal spaces 521, 522, and 523. The first lid part 44 is an example of a “connection member lid part” according to the present teachings.

The openings 42 for inserting the conductive terminals 342 into the terminal spaces 52S are formed in the first lid part 44. More specifically, the present embodiment includes openings 421, 422, and 423 respectively corresponding to the grooves 551, 552, and 553. The conductive terminals 342 corresponding to the lead wire parts 91p, 92p, and 93p are respectively inserted into the openings 421, 422, and 423.

In the present embodiment, inclined parts 442 are formed on the first lid part 44. The inclined parts 442 are formed between the openings 421, 422, and 423 of the first lid part 44 and the second lid part 46. The shape of the inclined parts 442 corresponds to the shape of the inclined parts 526T of the side wall part 526. Specifically, in a similar manner as the inclined parts 526T, the inclined parts 442 are configured to be inclined at a prescribed angle with respect (relative) to the bottom part 528.

FIG. 18 is a side view of the cover member 40. More specifically, FIG. 18 shows the cover member 40 in a state as viewed from the outer side Y1 in the radial direction toward the inner side Y2 in the radial direction, i.e., in the direction of arrow FC shown in FIG. 17. FIG. 18 also shows a virtual (broken) line 528L that coincides with the surface direction of the bottom part 528 (i.e., the lower surface thereof) of the connection member 52, and an inclination angle R1 of the inclined part(s) 442 with respect to the virtual line 528L. The inclination angle R1 can be set as desired. In the present embodiment, the inclination angle R1 is determined in advance to be an appropriate angle for the laser welding, as will be further explained below.

For ease of understanding of the technology, FIG. 18 schematically shows a laser oscillator LC that is used to carry out the laser welding on the cover member 40, and laser light LS emitted from the laser oscillator LC. The laser oscillator LC is disposed, for example, on the first side Z1 in the axial direction with respect to the connection member 52, the support member 50, and the cover member 40, and irradiates the laser light LS toward a boundary of the connection member 52 and the support member 50 with the cover member 40. As a result, the connection member 52 and the support member 50 are joined (fused) with the cover member 40.

As a comparative example, a configuration of a cover member that does not include the inclined part(s) 442 is shown by another broken line in FIG. 18. That is, in an embodiment in which the inclined part(s) 442 is (are) not formed as shown by the broken line (denoted by 442R) in FIG. 18, the first lid part 44 would include a wall surface 442R having a substantially rectangular shape between the opening 42 and the second lid part 46. Thus, in the comparative example shown by the broken line in FIG. 18, the wall surface 442R would be substantially parallel to the axial direction DZ. In this case, since an angle between an irradiation direction of the laser light LS and a surface direction of the wall surface 442R would be rather small, it could be difficult to irradiate the laser light LS over the entire wall surface 442R. Thus, there is a possibility that a defect might occur in the laser welding of the wall surface 442R and the connection member 52.

In contrast to this, in the present embodiment, the inclination angle R1 of the inclined part(s) 442 with respect to the bottom part 528 may be, e.g., approximately 30 degrees. Thus, it is possible to increase the angle between the irradiation direction of the laser light LS and the inclined part 442. Therefore, it becomes easier to irradiate the laser light LS emitted from the laser oscillator LC over the entire inclined part 442. As a result, it is possible to reduce the likelihood of or even prevent a defect from occurring in the laser welding of the connection member 52 and the cover member 40.

The inclination angle R1 is not limited to only being 30 degrees, and may be set in a desired angle range that is appropriate for the laser welding. However, by setting the inclination angle R1 to an angle equal to or greater than 15 degrees, the distance between the first lid part 44 and the second lid part 46 is shortened, and it is possible to reduce the likelihood of or even prevent the connection member 52 and the support member 50 from increasing in size in the circumferential direction DX or the radial direction DY. On the other hand, if the inclination angle R1 were to be set to an angle greater than 45 degrees, the angle between the irradiation direction of the laser light LS and the surface direction of the inclined part 442 would become smaller, thereby making it difficult to irradiate the laser light LS over the entire inclined part 442. In this case, the cover member 40 is preferably joined to the connection member 52 and the support member 50 using a method other than the laser welding. In view of the above explanations, the inclination angle R1 is preferably set to be in a range, e.g., from 15 degrees to 45 degrees, or more preferably, e.g., 25 degrees to 35 degrees.

### A8. Effects

As described above, according to the motor 310 of the present embodiment, the bottom part 528 (i.e. the surface thereof that is closest to the stator core 80) of the connection member 52 is disposed at a position in contact with one or more of the inner apex parts 716T of the first inner wall parts 716. Consequently, the lower surface of the connection member 52 (i.e. the surface of the connection member 52 closest to the stator core 80) can be disposed further toward the second side Z2 in the axial direction than the outer apex parts 712T. Thus, compared to an embodiment in the related art, in which the lower surface of the connection member 52 (i.e. the surface of the connection member 52 closest to the stator core 80) is disposed further toward the first side Z1 in the axial direction than the outer apex parts 712T of the first insulation part 71, the connection member 52 can be disposed in a more efficient (space saving) manner in the axial direction, thereby enabling the overall length of the motor 310 in the axial direction DZ to be shortened. Further, the length in the axial direction DZ of the motor chamber 303 of the compressor 300 can also be shortened, thereby enabling a reduction of the overall axial length of the compressor 300.

According to the motor 310 of the present embodiment, as shown in FIG. 15, the end portion (surface) 58B of the inner peripheral wall part 58 is configured to be in the same plane as the bottom part 528 (i.e. the surface of the bottom part 528 closest to the stator core 80) of the connection member 52 and the bottom part 59B (i.e. the surface of the bottom part 59B closest to the stator core 80) of the wire connection terminal compartment 59. The end portion 58B of the inner peripheral wall part 58, the bottom part 528 of the connection member 52, and the bottom part 59B of the wire connection terminal compartment 59 are configured to be in contact with at least some of the inner apex parts 716T. Therefore, the connection member 52 can be supported by (on) the electrical insulation body 70 via the plurality of contact points including at the end portion 58B of the inner peripheral wall part 58 and at the bottom part 59B of the wire connection terminal compartment 59. Thus, the connection member 52 can be disposed on the electrical insulation body 70 in the stable state, and wobbling of the connection member 52 can be curtailed or even prevented. For example, even in an environment, such as a vehicle, in which the installed compressor 300 and the motor 310 are likely to vibrate during operation, it is possible to curtail or prevent the occurrence of a failure of the motor 310 caused by vibrations, such as members of the motor 310 falling off due to the vibrations, or the like.

According to the motor 310 of the present embodiment, portions of the lead wire parts 90p (i.e. the portions of the lead wire parts 90p disposed in the grooves 712R) are disposed further toward the outer side Y1 in the radial direction than (radially outward of) the radially-inner circumferential surface of the first outer wall part 712. Thus, in the region further toward the inner side Y2 in the radial direction than (radially inward of) the first outer wall part 712 and further toward the second side Z2 in the axial direction than the outer apex parts 712T, it is possible to increase the size of the region in which the connection member 52 can be disposed. Therefore, the lower surface (the bottom part 528) of the connection member 52 (i.e. the surface of the connection member 52 closest to the stator core 80) can be disposed in the region further toward the second side Z2 in the axial direction than the outer apex parts 712T, thereby enabling a reduction of the axial length of the motor 310.

According to the motor 310 of the present embodiment, the first outer wall part 712 includes the grooves 712R for respectively disposing portions of the lead wire parts 90p in the outer peripheral surfaces 712W on the outer side Y1 in the radial direction (radially outward) of the first outer wall part 712. Thus, it becomes easier to dispose portions of the lead wire parts 90p further toward the outer side Y1 in the radial direction than (radially outward of) the first outer wall part 712. Further, by disposing portions of the lead wire parts 90p in the grooves 712R, the lead wire parts 90p can be electrically insulated from the lead wire parts 90p of the other phases using a simpler configuration than in an embodiment in which an insulating material covers the portions of the lead wire parts 90p disposed in the grooves 712R. Moreover, by omitting such an insulating material, it is possible to reduce the number of components (part count) of the stator 100, and it is also possible to enlarge the region in which the connection member 52 can be disposed on the first insulation part 71.

The motor 310 of the present embodiment includes the support member 50 connected to the connection member 52. The support member 50 is configured to be in contact with a plurality of locations on the first side Z1 in the axial direction of the stator 100. By using the support member 50, the connection member 52 can be supported by the electrical insulation body 70 via the plurality of contact points. Thus, the connection member 52 can be disposed on the electrical insulation body 70 in the more stable state (manner).

According to the motor 310 of the present embodiment, the support member 50 includes the outer peripheral wall part 56 that is connected to the connection member 52 and that extends in the circumferential direction DX. The outer peripheral wall part 56 is disposed facing the outer peripheral surfaces 712W on the outer side Y1 in the radial direction (radially outward) of the first outer wall part 712, and further toward the outer side Y1 in the radial direction than (radially outward of) the first outer wall part 712. Thus, the portions of the lead wire parts 90p disposed in the grooves 712R in the outer peripheral surfaces 712W can be reliably electrically insulated from other conductive components. Therefore, it is possible to reduce or even prevent the likelihood of an electrical short circuit or a flashover between the lead wire parts 90p and conductive components included in the compressor 300, such as the wall surfaces of the motor chamber 303, or other conductive components included in the motor 310.

According to the motor 310 of the present embodiment, the outer peripheral wall part 56 includes the outer wall projections 564 that protrude toward the inner side Y2 in the radial direction (radially inward) and extend in the circumferential direction DX. The first outer wall part 712 includes the outer wall recesses 712V into which the outer wall projections 564 can be respectively fitted (inserted). Because the outer wall projections 564 are fitted (inserted) within the outer wall recesses 712V, movement (rotation) of the main body 560 in the circumferential direction DX is restricted (blocked), such that the connection member 52 and the support member 50 can be disposed on the stator 100 in the stable state (manner). Thus, wobbling of the connection member 52 and the support member 50 in the circumferential direction DX can be curtailed, and it is possible to reduce or prevent the likelihood of a failure of the motor 310 caused by vibrations.

According to the motor 310 of the present embodiment, the first outer wall part 712 includes the engagement parts 718 configured to engage with the outer peripheral wall part 56. Due to the engagement between the outer peripheral wall part 56 and the engagement parts 718, movement of the main body 560 in the axial direction DZ and in the radial direction DY is restricted (blocked), such that the connection member 52 and the support member 50 can be disposed on the electrical insulation body 70 in the stable state (manner). Thus, wobbling of the connection member 52 and the support member 50 in the axial direction DZ and in the radial direction DY is curtailed, and it is possible to reduce or even prevent the likelihood of a failure of the motor 310 caused by vibrations.

According to the motor 310 of the present embodiment, the outer peripheral wall part 56 includes the outer peripheral wall flanges 562 that protrude toward the inner side Y2 in the radial direction (radially inward) and extend in the circumferential direction DX. The outer peripheral wall flanges 562 are respectively engaged between the claw parts 718N and the outer apex parts 712T. Because the engagement parts 718 are designed as snap fit structures, the outer peripheral wall flanges 562 and the engagement parts 718 can be engaged by performing a simple method.

According to the motor 310 of the present embodiment, the end portion (surface) 58B of the inner peripheral wall part 58 is configured to be in contact with one or more of the inner apex parts 716T of the inner wall parts 732. By utilizing this type of configuration, the peripheral edge on the inner side Y2 in the radial direction (i.e., the radially inner peripheral edge) of the support member 50 is supported by (on) the first insulation part 71. Thus, wobbling in the axial direction DZ along the inner peripheral edge of the support member 50 is curtailed, whereby it is possible to reduce or even prevent the likelihood of a failure of the motor 310 caused by vibrations.

Further, according to the motor 310 of the present embodiment, the end portion (surface) 56B of the outer peripheral wall part 56 is further configured to be in contact with the flange 719 of the outer peripheral edge of the first insulation part 71. By utilizing this type of configuration, the peripheral edge on the outer side Y1 in the radial direction of the support member 50 is supported by (on) the first insulation part 71. Thus, wobbling in the axial direction DZ at the outer peripheral edge of the support member 50 is curtailed, whereby it is possible to reduce or even prevent the likelihood of a failure of the motor 310 caused by vibrations.

According to the motor 310 of the present embodiment, both the inner peripheral edge and the outer peripheral edge of the support member 50 are supported by (on) the first insulation part 71. In other words, the entire support member 50 is configured to be supported by (on) the first insulation part 71. Thus, wobbling of the support member 50 in the axial direction DZ is curtailed, whereby it is possible to reduce or more reliably prevent the likelihood of a failure of the motor 310 caused by vibrations.

According to the motor 310 of the present embodiment, the support member 50 includes the lead wire compartment 55 that is configured to guide the lead wire parts 90p to the connection member 52. Thus, the lead wire parts 90p can be disposed on the stator 100 in a stable state using the support member 50.

According to the motor 310 of the present embodiment, the support member 50 includes the wire connection terminal compartment 59 that is connected to the connection member 52 and the support member 50, and that is configured to be able to house the wire connection terminal 60 that forms the neutral point connection of the other (second) ends of the stator windings 90. The wire connection parts 90q forming the neutral point connection, and the wire connection terminal 60 are supported by (in) the support member 50. Thus, the wire connection parts 90q can be supported on the stator 100 in a stable state.

The motor 310 of the present embodiment also includes the cover member 40. The cover member 40 includes the openings 42 (more specifically, 421-423) for inserting the conductive terminals 342, and includes the first lid part 44 disposed facing the bottom part 528, and the second lid part 46 configured to face the lead wire compartment 55. The lead wire parts 90p and the wire connection parts 90q disposed on (in) the support member 50 or the connection member 52 can be protected from the external environment and the like by the cover member 40. Thus, it is possible to reduce the likelihood of or even prevent an electrical short circuit from occurring between the lead wire parts 90p or the wire connection parts 90q and other conduction members of the compressor 300 or the motor 310. Further, since the cover member 40 is manufactured separately from the support member 50, the lead wire parts 90p and the wire connection parts 90q can be easily disposed on (in) the support member 50 before placing the cover member 40 on the support member 50.

According to the motor 310 of the present embodiment, between the openings 42 and the second lid part 46, the first lid part 44 includes the inclined parts 442 that are inclined at an inclination angle R1 of approximately 30 degrees (more generally, 15-45 degrees) with respect to the bottom part 528. Thus, it is possible to reduce the likelihood of or even prevent a defect when laser welding (fusing together) the cover member 40 and the connection member 52.

### A9. Modified Examples

In the above-described first embodiment, an example was described in which the bottom part 528 of the connection member 52 is disposed at a position in contact with one or more of the inner apex parts 716T of the first inner wall parts 716. However, in an alternate embodiment according to the present teachings, the bottom part 528 of the connection member 52 may instead be disposed at a position other than the position in contact with one or more of the inner apex parts 716T. For example, as long as the position of the bottom part 528 of the connection member 52 results in a state in which the connection member 52, or at least a part of the support member 50 connected to the connection member 52, is supported by (on) the electrical insulation body 70, the bottom part 528 can be fixed at any desired position.

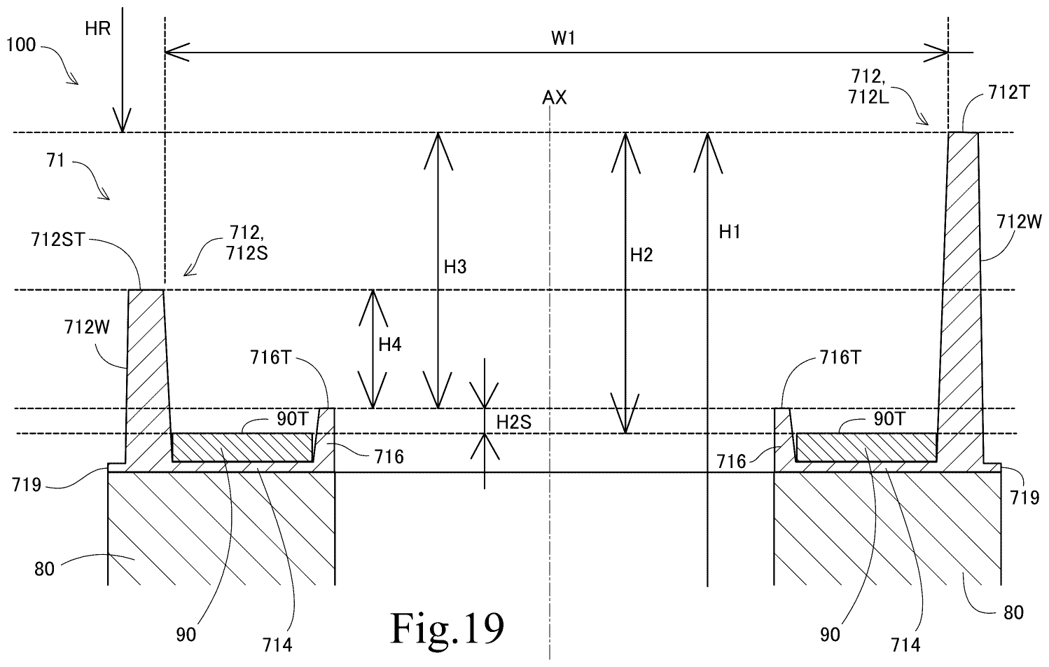

FIG. 19 is an explanatory view showing a modified example of an arrangement position of the connection member 52. FIG. 19 schematically shows a cross-section of the first side Z1 in the axial direction of the stator 100. Note that the configuration of each of parts shown in FIG. 19 is schematically shown, and dimensions and shapes of each of the parts are not necessarily drawn to scale.

The bottom part 528 of the connection member 52 (not shown in FIG. 19 for clarity purposes) may be disposed at any desired position within a region (range) W1 further toward the inner side Y2 in the radial direction than (radially inward of) the first outer wall part 712 and also within a first region (range) H1 that is further toward the second side Z2 in the axial direction than the outer apex parts 712T, as shown in FIG. 19. Thus, according to the motor 310 of this modified example, the lower surface of the connection member 52 (i.e. the surface of the connection member 52 closest to the stator core 80) can be disposed further toward the second side Z2 in the axial direction than the outer apex parts 712T (i.e. below the upper surfaces of the outer apex parts 712T in FIG. 19). Thus, as compared to an embodiment in the related art, in which the entire connection member 52 is disposed in a region HR further toward the first side Z1 in the axial direction than the outer apex parts 712T of the first insulation part 71 (i.e. the entire connection member 52 is disposed above the upper surfaces of the outer apex parts 712T in FIG. 19), the length of the motor 310 in the axial direction DZ can be shortened.

As shown in FIG. 19, in the first region H1, the bottom part 528 of the connection member 52 may be disposed within a second region (range) H2 extending from end portions (surfaces) 90T on the first side Z1 in the axial direction of the coils (90) to the outer apex parts 712T (i.e. up to the upper surfaces of the outer apex parts 712T in FIG. 19). Therefore, in this modified example, regardless of the position of the inner apex parts 716T, the position of the bottom part 528 can be set based on an arrangement relationship with the coils. For example, even if the end portions (surfaces) 90T of the coils (90) on the first side Z1 in the axial direction of the coil part are disposed further toward the first side Z1 in the axial direction than the inner apex parts 716T, the length of the motor 310 in the axial direction DZ can still be shortened compared to the related art.

Furthermore, in the example shown in FIG. 19, the end portions (surfaces) 90T on the first side Z1 in the axial direction of the coil(s) is (are) disposed further toward the second side Z2 in the axial direction than the inner apex parts 716T. Therefore, in this modified example, the bottom part 528 can be disposed, within the second region H2, in a sub-region (sub-range) H2S extending from the end portion(s) 90T (i.e. from the upper surfaces of coil(s) 90 in FIG. 19) on the first side Z1 in the axial direction of the coil(s) to the inner apex parts 716T. Thus, if the motor 310 is configured in this way, the length of the motor 310 in the axial direction DZ can be further shortened.

As shown in FIG. 19, the bottom part 528 of the connection member 52 can be disposed within a third region (range) H3 extending from (the upper surfaces of) the inner apex parts 716T to (the upper surfaces of) the outer apex parts 712T. Even if structural members other than the connection member 52 are disposed between the inner apex parts 716T and the outer apex parts 712T, the length of the motor 310 in the axial direction DZ can be shortened as compared to the related art, while also disposing the other members therein. For example, this applies to an embodiment in which the end portions (surfaces) 90T on the first side Z1 in the axial direction of the coils are disposed further toward the first side Z1 in the axial direction than the inner apex parts 716T.

In the modified example shown in FIG. 19, the first outer wall part 712 includes the longest wall portions 712L and the shortest wall portions 712S. The end portion (surface) on the first side Z1 in the axial direction of the shortest wall portions 712S is defined as “shortest outer apex part 712ST”. In this case, the bottom part 528 may be disposed in a fourth region (range) H4 extending from (the upper surfaces of) the inner apex parts 716T to (the upper surfaces of) the shortest outer apex parts 712ST. Even in such an embodiment, the length of the motor 310 in the axial direction DZ can still be shortened. Further, if it is assumed that (the upper surfaces (in FIG. 19) of) the outer apex parts 712T are located further toward the second side Z2 in the axial direction than the end portions (surfaces) on the first side Z1 in the axial direction of the connection member 52. In this case, the length of the longest wall portions 712L in the axial direction DZ can be set, for example, to be longer than the length in the axial direction DZ of the first outer wall part 712 in the related art. In this case, the lead wire parts 90p can be more easily disposed on the outer peripheral surfaces 712W (i.e., in the grooves 712R thereof).

### B. Second Embodiment

### B1. Configuration of Motor 310b and Stator 100b

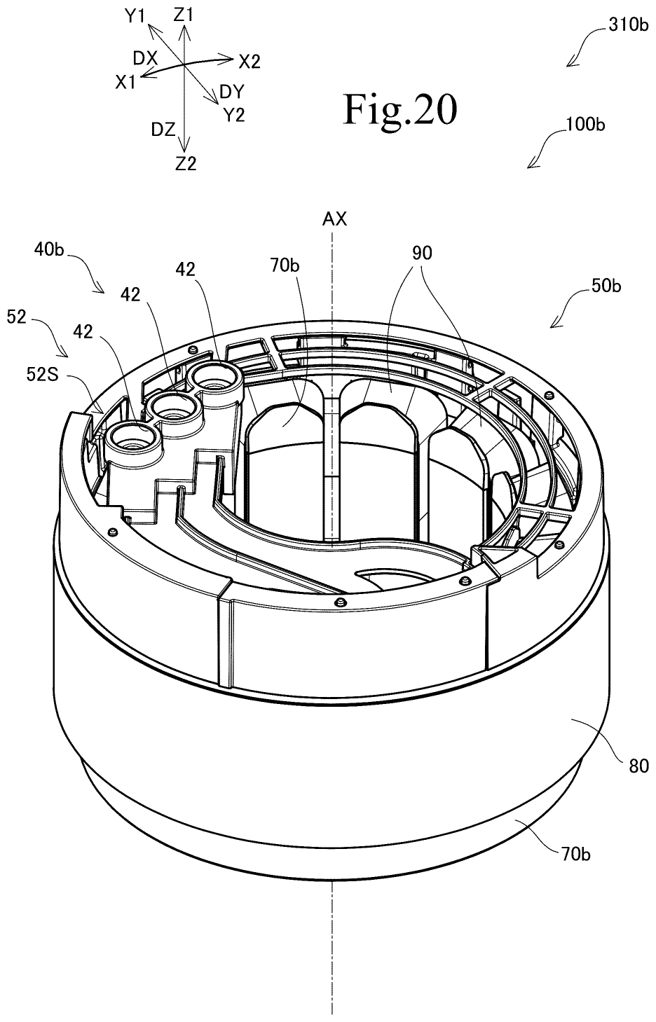

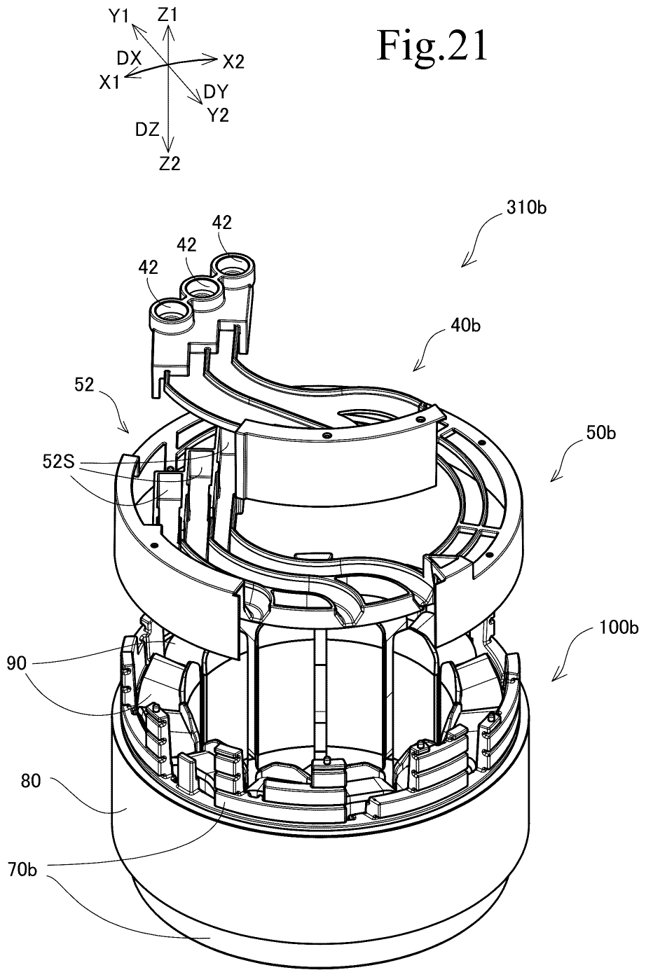

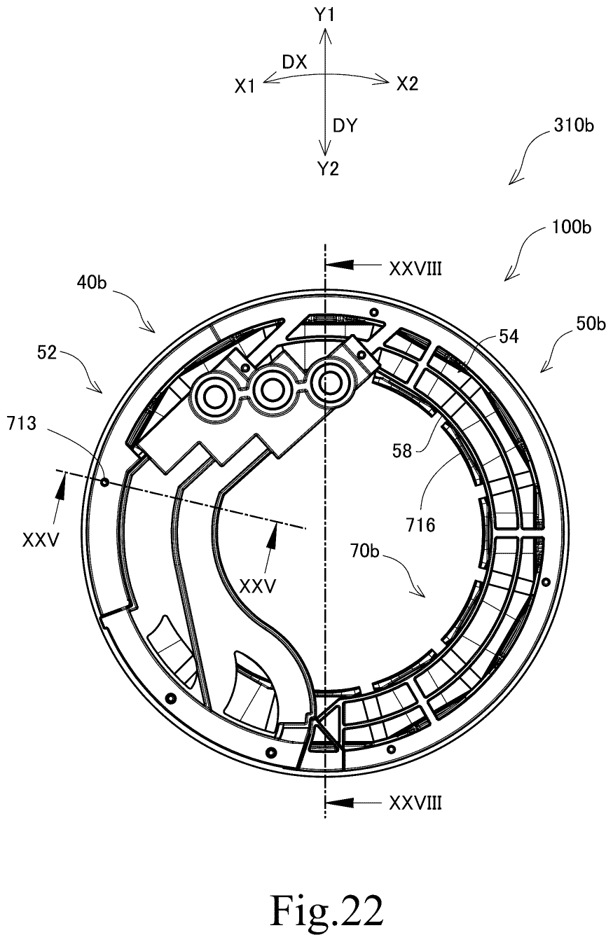

FIG. 20 is an explanatory view showing the configuration of a motor 310b according to a second embodiment of the present disclosure. FIG. 21 is an exploded perspective view showing the configuration (shapes) of some of the parts of the motor 310b according to the second embodiment. FIG. 22 is a plan view of the motor 310b according to the second embodiment. Note that, in FIG. 20 to FIG. 22, for ease of understanding of the technology, the rotor 200 is not illustrated. In the above-described first embodiment, an example of a motor 310 including the stator 100 in which the stator windings 90 are Y-connected was described. In contrast, the motor 310b according to the present embodiment includes a stator 100b in which the stator windings 90 are delta-connected.

As shown in FIG. 20 to FIG. 22, the motor 310b differs from the motor 310 according to the first embodiment in that the motor 310b includes the stator 100b in place of the stator 100, includes a support member 50b in place of the support member 50, and includes a cover member 40b in place of the cover member 40. The remaining configuration of the motor 310b is the same as that of the motor 310 according to the first embodiment. As was noted above, the stator 100b differs from the stator 100 according to the first embodiment in that the stator windings 90 of the stator 100b are delta-connected instead of being Y-connected. Due to this change, the stator 100b includes an electrical insulation body 70b in place of the electrical insulation body 70. The remaining configuration of the stator 100b is the same as that of the stator 100 shown in the first embodiment.

### B2. Configuration of Electrical Insulation Body 70b

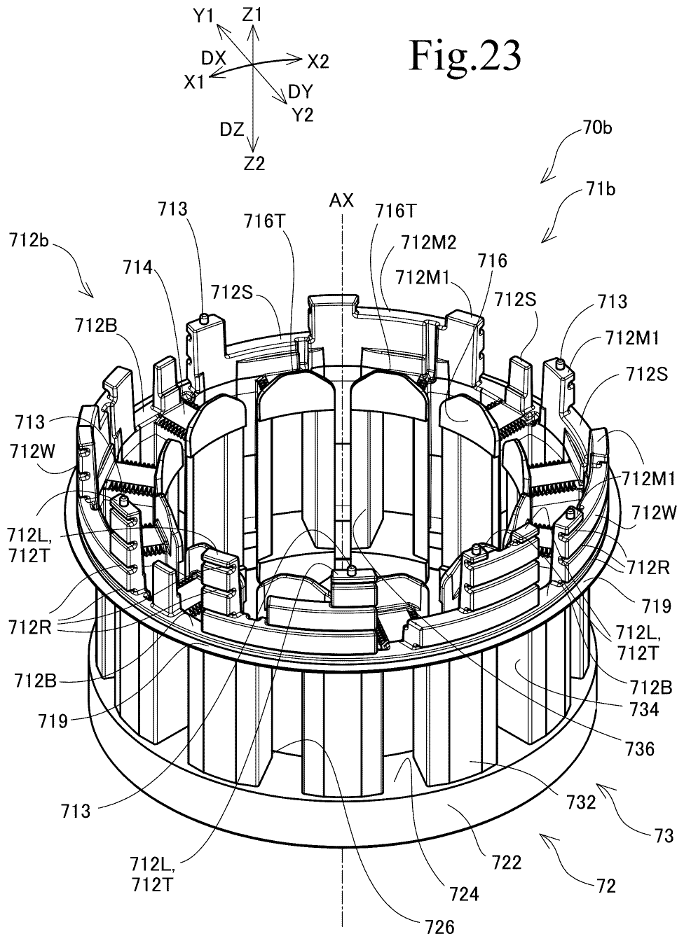

FIG. 23 is an explanatory view showing the configuration of the electrical insulation body 70b. The electrical insulation body 70b differs from the electrical insulation body 70 shown in the first embodiment in that the electrical insulation body 70b includes a first insulation part 71b in place of the first insulation part 71, whereas the remaining configuration of the electrical insulation body 70b is the same as that of the electrical insulation body 70. The first insulation part 71b differs from the first insulation part 71 in that the first insulation part 71b includes a first outer wall part 712b in place of the first outer wall part 712.

The first outer wall part 712b has the same configuration as the first outer wall part 712 in that the first outer wall part 712b includes the bottom wall portions 712B, the shortest wall portions 712S, and the longest wall portions 712L. The first outer wall part 712b differs in that the first outer wall part 712b includes two types of medium wall portions in place of (the single type of) the medium wall portions 712M, namely medium wall portions 712M1 and medium wall portions 712M2, which have differing lengths in the axial direction DZ. In this way, the first insulation part 71b may be designed to include multiple types of the medium wall portions 712M having the differing lengths in the axial direction DZ.

In the above-described first embodiment, an example was described in which the maximum number of grooves 712R formed in the axial direction DZ in the outer peripheral surfaces 712W of the longest wall portions 712L is three. In contrast, in the present second embodiment, four of the grooves 712R are formed in the axial direction DZ in the outer peripheral surfaces 712W of the longest wall portions 712L. Note that, in order to form wiring paths corresponding to a delta connection, in addition to the grooves 712R corresponding to the single lead wire parts 90p for each of the U phase, the V phase, and the W phase, the four grooves 712R further include another groove 712R corresponding to a further single lead wire part 90p for any one of the U phase, the V phase, and the W phase (in the present embodiment, the W phase).

Furthermore, in the above-described first embodiment, the engagement parts 718 are formed on the apex parts 712T of the first outer wall part 712. In contrast, in the present second embodiment, protrusions 713 are formed on the first outer wall part 712b in place of the engagement parts 718. Note that the protrusions 713 are respectively formed on the end portions (surfaces) on the first side Z1 in the axial direction of the medium wall portions 712M1, in addition to on the outer apex parts 712T.

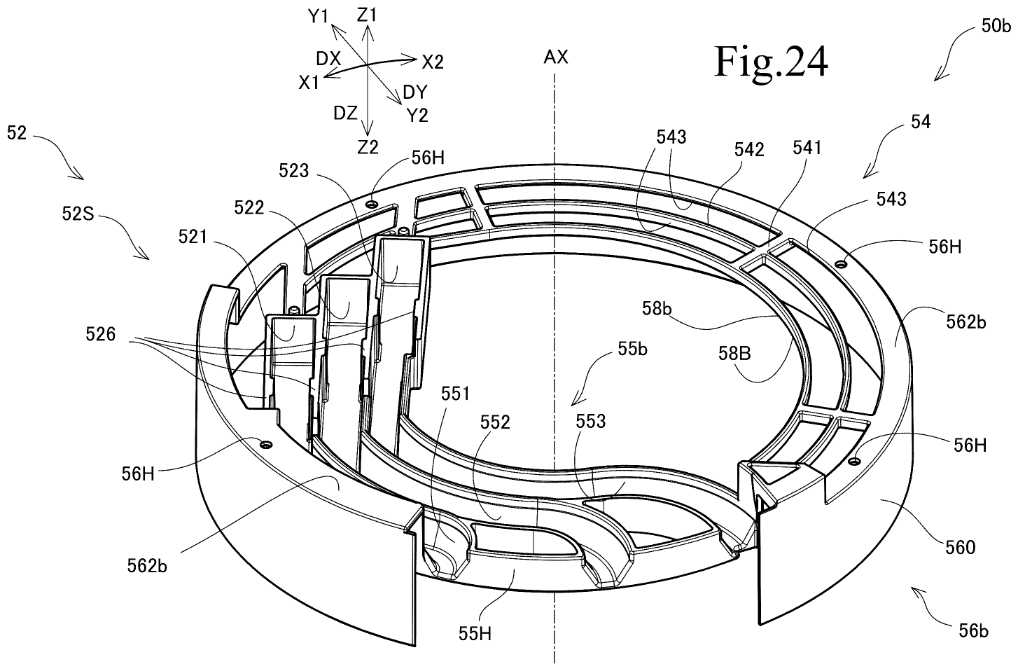

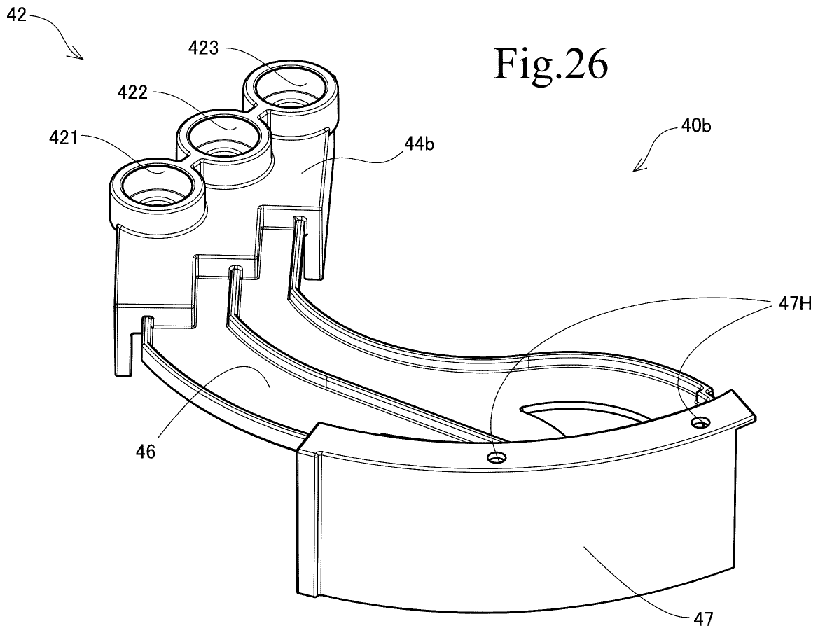

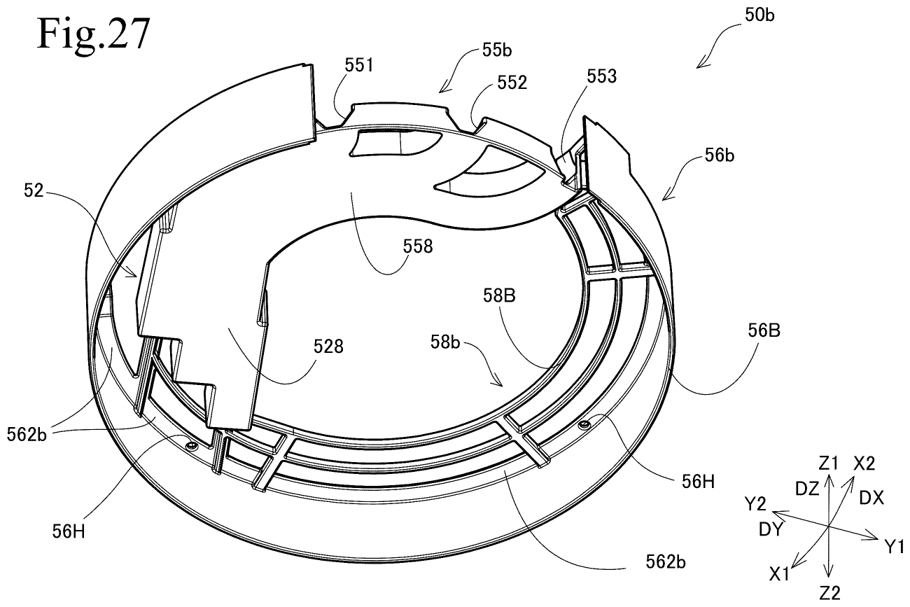

As will be further described below, the protrusions 713 are configured to fit in (to be inserted into) openings 47H formed in the cover member 40 (see FIG. 26), and openings 56H formed in the support member 50 (see FIGS. 24 and 27). Thus, the protrusions 713 are formed (located) at positions corresponding to the openings 47H and the openings 56H. The protrusions 713 are not limited to being formed on the outer apex parts 712T and/or on the medium wall portions 712M1, and may (in addition and/or instead) be formed, e.g., on one or more of the medium wall portions 712M2, the shortest wall portions 712S, and/or the bottom portions 712B. The protrusions 713 are an example of a “fitting part having a convex shape” according to the present teachings. Openings that function as a “fitting part having a concave shape” may be formed in place of one or more of the protrusions 713.

### B3. Configuration of Support Member 50b

FIG. 24 is an explanatory view showing the configuration (shape) of the support member 50b. The support member 50b differs from the support member 50 shown in the first embodiment in that the support member 50b includes an outer peripheral wall part 56b in place of the outer peripheral wall part 56, a lead wire compartment 55b in place of the lead wire compartment 55, an inner peripheral wall part 58b in place of the inner peripheral wall part 58, and in that the support member 50b does not include the wire connection terminal compartment 59. The remaining configuration is the same as that of the support member 50. The inner peripheral wall part 58b differs from the inner peripheral wall part 58 shown in the first embodiment in that an end portion (surface) 58B on the second side Z2 in the axial direction (see FIG. 27) is not in contact with the inner apex parts 716T, and the remaining configuration is the same as that of the inner peripheral wall part 58. Note that the functional configuration of the connection member 52 is the same as the functional configuration of the connection member 52 shown in the first embodiment, and a description thereof is thus omitted here.

The U-phase lead wire part 91p, the V-phase lead wire part 92p, and the W-phase lead wire part 93p including the one (first) ends of the stator windings 90, and a U-phase lead wire part 91p2 (not shown in the drawings), a V-phase lead wire part 92p2 (not shown in the drawings), and a W-phase lead wire part 93p2 (not shown in the drawings) that are the other (second) ends of the stator windings 90 are connected to each other. The connected lead wire parts 90p are pulled (extend) out from the stator 100b toward the first side Z1 in the axial direction of the support member 50b via (through) an opening 55H of (in) the support member 50b. In the present embodiment, a UV-phase lead wire part obtained by connecting the U-phase lead wire part 91p and the V-phase lead wire part 92p2, a VW-phase lead wire part obtained by connecting the V-phase lead wire part 92p and the W-phase lead wire part 93p2, and a WU-phase lead wire part obtained by connecting the W-phase lead wire part 93p and the U-phase lead wire part 91p2 are respectively disposed in the grooves 551, 552, and 553 of the lead wire compartment 55b. In a similar manner as the above-described first embodiment, the lead wire compartment 55b electrically insulates the lead wire parts disposed in the grooves 551, 552, and 553 of the lead wire compartment 55b from other conductive components, such as the lead wire parts disposed in the adjacent groove(s), the coils and the like. Because the lead wire parts are respectively disposed in the grooves 551, 552, and 553 of the lead wire compartment 55b, it is possible to omit an insulating material to cover the lead wire parts to provide electrical insulation with respect to other conductive components. Thus, it is possible to electrically insulate the lead wire parts using a simpler configuration than in the related art.

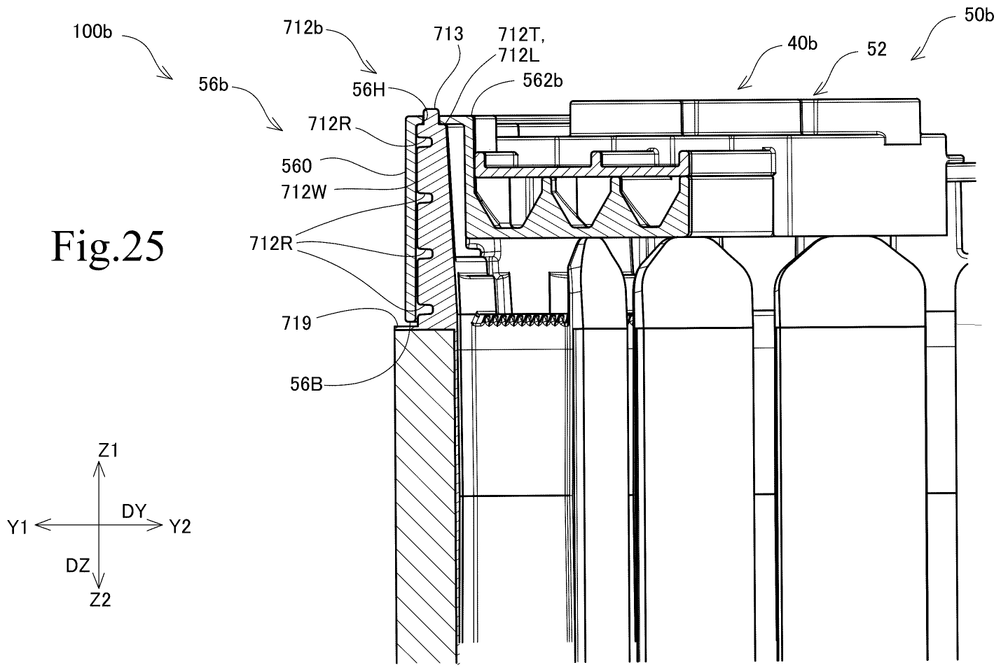

FIG. 25 is a sectional view of cross-section XXV-XXV shown in FIG. 22. The outer peripheral wall part 56b includes the main body 560 and outer peripheral wall flanges 562b (see also FIG. 27). As shown in FIG. 24 and FIG. 25, the outer peripheral wall part 56b differs from the outer peripheral wall part 56 shown in the first embodiment in that the outer peripheral wall part 56b does not include the outer wall projections 564, and in that the outer peripheral wall part 56b includes the outer peripheral wall flanges 562b in place of the outer peripheral wall flanges 562. The remaining configuration is the same as that of the outer peripheral wall part 56. Note that, in the present embodiment, the end portion (surface) 56B of the outer peripheral wall part 56 is not in contact with the flange 719 of the first insulation part 71, but the end portion (surface) 56B may be modified to be in contact with the flange 719 in alternate embodiments of the present teachings.

The outer peripheral wall flanges 562b are formed on the end portion (surface) on the first side Z1 in the axial direction of the main body 560. As shown in FIGS. 24 and 27, in the present embodiment, the outer peripheral wall flanges 562b extend in the circumferential direction DX, and are formed over most of the circumference of the outer peripheral edge of the support member 50b. As shown in FIG. 25, the outer peripheral wall flanges 562b are configured to be in contact with the outer apex parts 712T of the longest wall portions 712L.

The openings 56H are formed in the outer peripheral wall flanges 562b. The openings 56H each have a shape corresponding to the shape of the protrusions 713 formed on the first outer wall part 712b, and are configured to receive (mate, fit with) the corresponding protrusions 713. After being inserted (fitted) into the openings 56H, such protrusions 713 are bonded (fused) to the outer peripheral wall flanges 562b, e.g., by laser welding or thermal welding. Because the protrusions 713 are bonded (permanently affixed) in the openings 56H, it is possible to restrict (block) movement of the connection member 52 and the support member 50b in the radial direction DY and to restrict (block) rotation of the connection member 52 and the support member 50b in the circumferential direction DX. Thus, wobbling of the connection member 52 and the support member 50b in the radial direction DY and the circumferential direction DX can be curtailed, whereby it is possible to reduce the likelihood of or even prevent the occurrence of a failure of the motor 310b caused by vibrations. The openings 56H are an example of a “to-be-fitted part having a concave shape corresponding to a shape of a fitting part” according to the present teachings. In place of the openings 56H, the protrusions may be formed to function as a “to-be-fitted part having a convex shape corresponding to a shape of a fitting part” according to the present teachings. Note that the fitting (mating) of the protrusions 713 and the openings 56H may be a loose fit in which a gap remains between each of the protrusions 713 and the openings 56H, or may be a tight fit (e.g., a friction fit) with no gap between the respective protrusions 713 and openings 56H.

### B4. Configuration of Cover Member 40b

FIG. 26 is an explanatory view showing the configuration (shape) of the cover member 40b. The cover member 40b differs from the cover member 40 shown in the first embodiment in that the cover member 40b includes a first lid part 44b in place of the first lid part 44, the cover member 40b does not include the third lid part 48, and the cover member 40b includes an outer peripheral wall part 47. The remaining configuration is the same as that of the cover member 40.

The first lid part 44b differs from the first lid part 44 in that the first lid part 44b does not include the inclined parts 442. The outer peripheral wall part 47 functions in a similar manner to the outer peripheral wall part 56b of the support member 50b. Because the cover member 40b is bonded (fused, affixed) to the support member 50b, the outer peripheral wall part 47 is integrated with the outer peripheral wall part 56b and functions as a part of the outer peripheral wall part 56b. The openings 47H have the same function as the openings 56H. In other words, the openings 47H function as a “to-be-fitted part having the concave shape corresponding to the shape of the fitting part” according to the present teachings. Note that the first lid part 44b may be provided with the inclined parts 442 in additional embodiments of the present teachings.

### B5. Configuration of Second Side Z2 in the Axial Direction of the Support Member 50b

FIG. 27 is a perspective view showing the configuration (shape) of the second side Z2 in the axial direction of the support member 50b. The lead wire compartment 55b (see also FIG. 24) includes a bottom part (wall, surface) 558 that is the wall surface on the second side Z2 in the axial direction. As shown in FIG. 27, in the present embodiment, in place of the end portion (surface) 58B on the second side Z2 in the axial direction of the inner peripheral wall part 58b (see e.g., FIG. 14), the bottom part 558 of the lead wire compartment 55b is configured to be in the same place as (or continuous with) the bottom part 528 of the connection member 52.

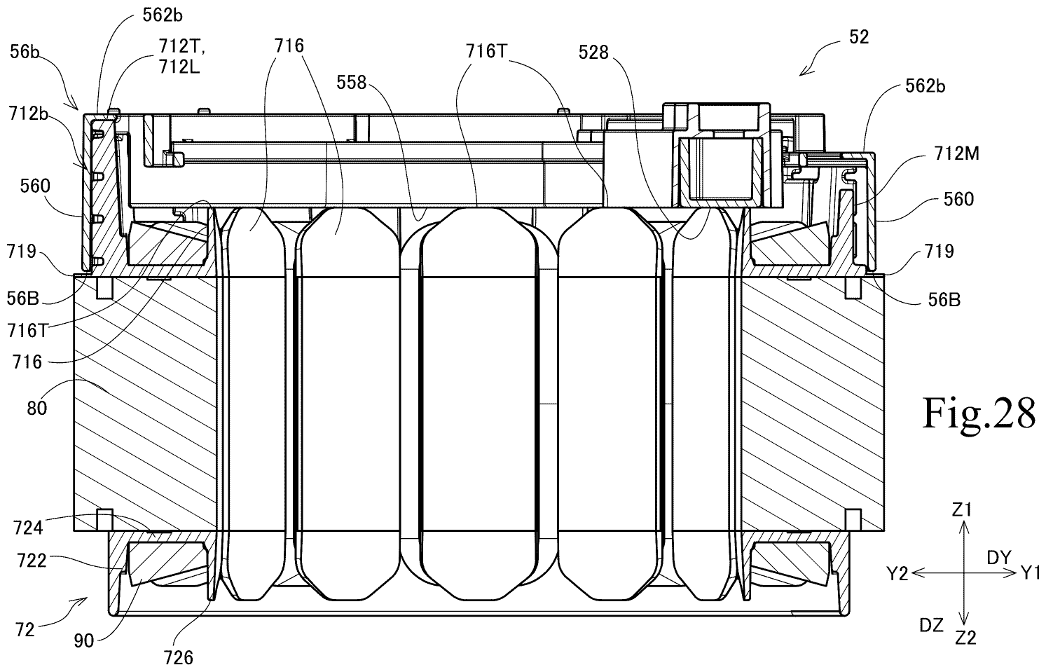

FIG. 28 is a sectional view of cross-section XXVIII-XXIII shown in FIG. 22. As shown in FIG. 28, in the present embodiment, the bottom part 528 of the connection member 52 is disposed at a position in contact with one or more of the inner apex parts 716T of the first inner wall parts 716. Thus, according to the motor 310b of the present embodiment, the length of the motor 310b in the axial direction DZ can be shortened in a similar manner to the above-described first embodiment. Further, the length in the axial direction DZ of the motor chamber 303 of the compressor 300 can be shortened, such that the axial length of the compressor 300 can be reduced.

As shown in FIGS. 27 and 28, according to the motor 310b of the present embodiment, the bottom part 558 of the lead wire compartment 55b and the bottom part 528 of the connection member 52 are configured to be in the same plane, and both are disposed to be in contact with multiple ones of the inner apex parts 716T of the first inner wall parts 716. The connection member 52 and the support member 50b are supported by (on) the first insulation part 71b, and movement of the connection member 52 and the support member 50b in the axial direction DZ is restricted (blocked). Thus, wobbling of the connection member 52 and the support member 50b in the axial direction DZ is curtailed, whereby it is possible to reduce the likelihood of or even prevent the occurrence of a failure of the motor 310b caused by vibrations.

Moreover, according to the motor 310b of the present embodiment, the outer peripheral wall flanges 562b of the outer peripheral wall part 56b are configured to be in contact with at least some of the outer apex parts 712T of the first insulation part 71b. By utilizing this type of configuration, the peripheral edge on the outer side Y1 in the radial direction of the support member 50b (i.e. the radially outer peripheral edge of the support member 50b) is supported by (on) the first insulation part 71b. Thus, wobbling of the outer peripheral edge of the support member 50b in the axial direction DZ is curtailed, whereby it is possible to reduce the likelihood of or even prevent the occurrence of a failure of the motor 310b caused by vibrations.

According to the motor 310b of the present embodiment, the protrusions 713 are provided on the outer apex parts 712T of the first outer wall part 712b, and the openings 56H corresponding to the protrusions 713 are formed in the outer peripheral wall flanges 562b. Thus, wobbling of the connection member 52 and the support member 50b in the radial direction DY and the circumferential direction DX is curtailed, whereby it is possible to reduce the likelihood of or even prevent the occurrence of a failure of the motor 310b caused by vibrations.

### C. Third Embodiment

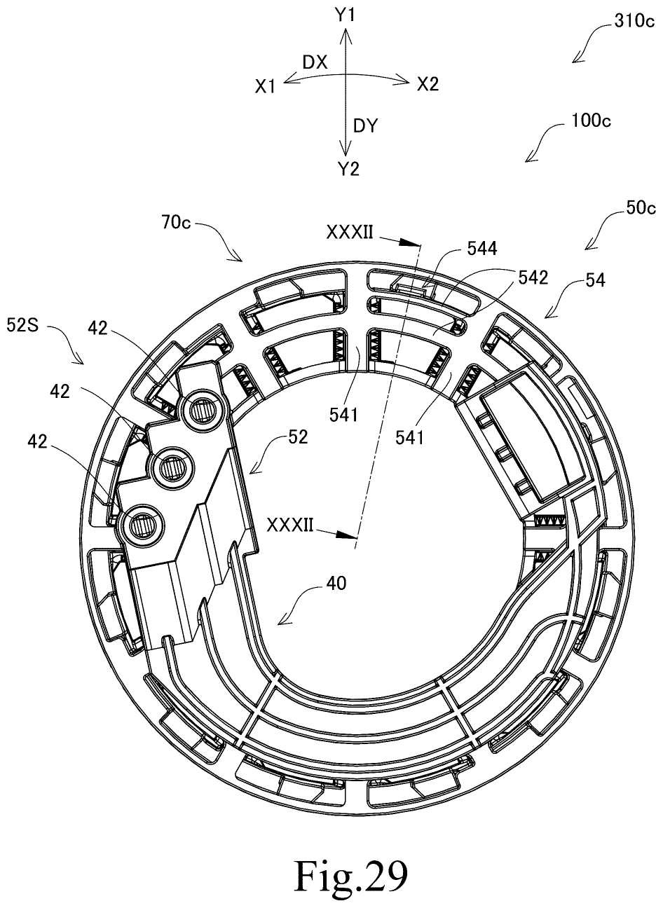

The configuration of a motor 310c according to a third embodiment of the present disclosure will now be described with reference to FIG. 29 to FIG. 32. FIG. 29 is an explanatory view showing the configuration of the motor 310c according to the third embodiment of the present disclosure. As indicated in FIG. 29, the motor 310c according to the third embodiment differs from the motor 310 according to the first embodiment in that the motor 310c includes a stator 100c in place of the stator 100, and the remaining configuration is the same as that of the motor 310. The stator 100c differs from the stator 100 in that the stator 100c includes an electrical insulation body 70c in place of the electrical insulation body 70, and includes a support member 50c in place of the support member 50.

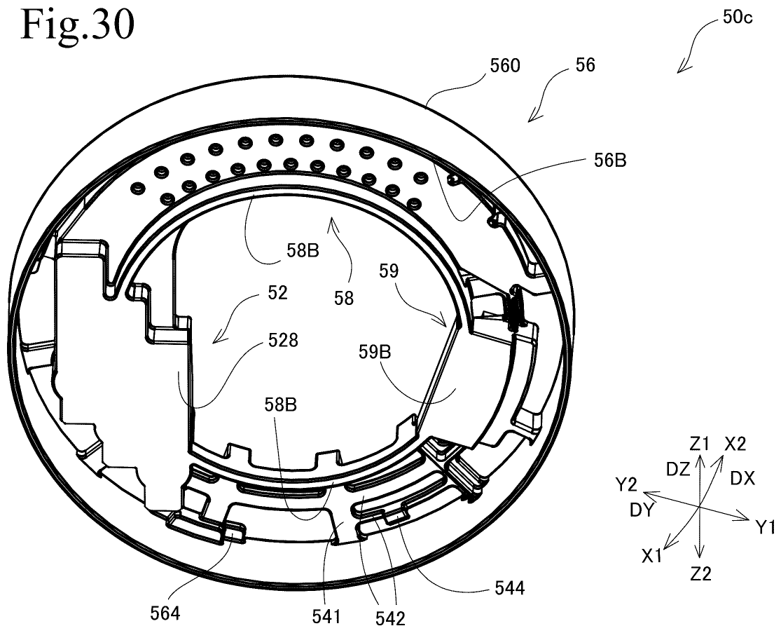

FIG. 30 is a perspective view showing the configuration of the second side Z2 in the axial direction of the support member 50c. The support member 50c differs from the support member 50 shown in the first embodiment in that the support member 50c does not include the outer peripheral wall flanges 562, but further includes at least one protrusion 544. As shown in FIG. 30, the protrusion 544 is formed on the second side Z2 in the axial direction of the second bridge member 542 of the support member 50c, and protrudes toward the outer side Y1 in the radial direction (radially outward) from the second bridge member 542. The protrusion 544 is an example of a “first engagement part” according to the present teachings. Note that, in FIG. 30, although the support member 50c includes only the single protrusion 544, the support member 50c may instead include a plurality of the protrusions 544, such as two or more, in other embodiments of the present teachings.

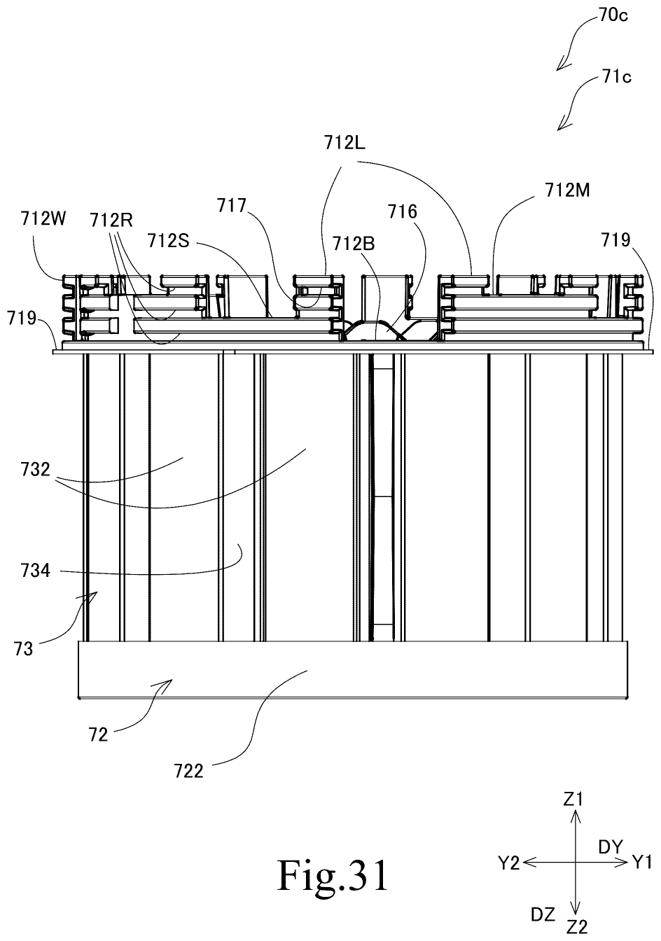

FIG. 31 is an explanatory view showing the configuration of the radially outer side of the electrical insulation body 70c. The electrical insulation body 70c differs from the electrical insulation body 70 shown in the first embodiment in that the electrical insulation body 70c includes a first insulation part 71c in place of the first insulation part 71. The first insulation part 71c differs from the first insulation part 71 shown in the first embodiment in that, in place of the engagement parts 718, a through hole 717 is formed in one of the longest wall portions 712L.

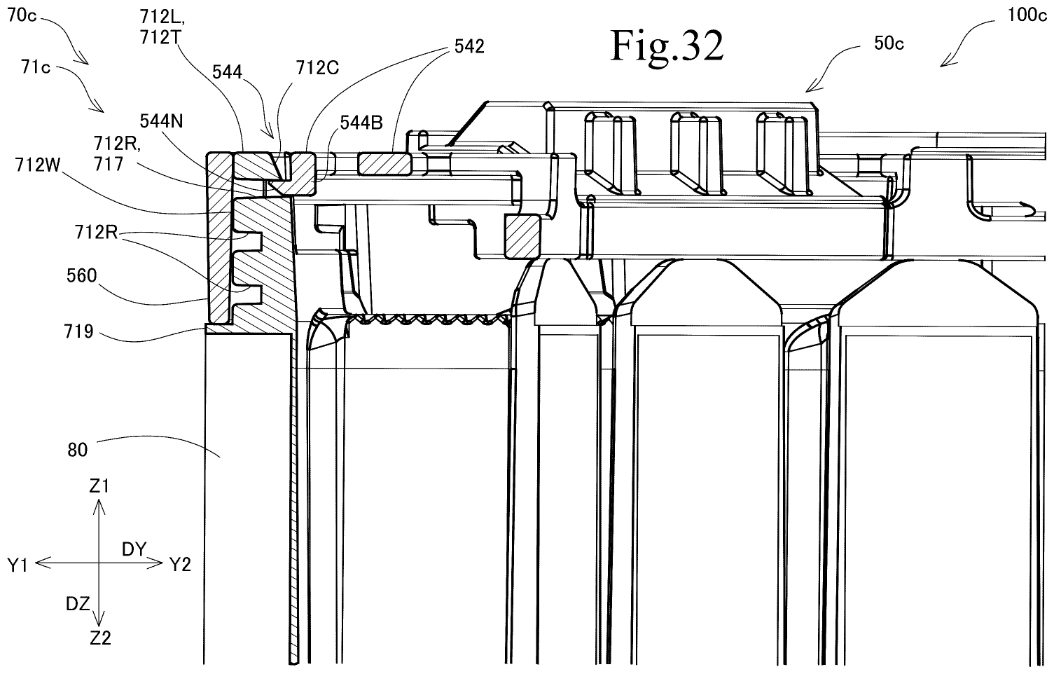

The through hole 717 penetrates through the outer peripheral surface 712W on the outer side Y1 in the radial direction of the first outer wall part 712 (i.e. through a bottom surface of one of the grooves 712R in the example shown in FIG. 31) to a (radially inward) wall surface on the inner side Y2 in the radial direction of the first outer wall part 712. The through hole 717 has a shape corresponding (complementary) to the shape of the protrusion 544, and is configured to engage with the protrusion 544. The through hole 717 is an example of a “second engagement part” according to the present teachings. Because the protrusion 544 is engaged (inserted) in the through hole 717, movement of the support member 50c in the axial direction DZ and the circumferential direction DX with respect (relative) to the first insulation part 71c is restricted (blocked), such that the connection member 52 and the support member 50c can be disposed on the first insulation part 71c in a stable state (manner). In the present embodiment, an inclined surface 712C (see FIG. 32) is formed on the first side Z1 in the axial direction of the through hole 717.

FIG. 32 is a sectional view of cross-section XXXII-XXXII shown in FIG. 29. In FIG. 32, a state is shown in which the protrusion 544 is engaged in the through hole 717. The inclined surface 712C is formed on a (radially inner) wall surface on the inner side Y2 in the radial direction of one of the longest wall portions 712L. The inclined surface 712C is inclined so as to increasingly protrude toward the inner side Y2 in the radial direction (radially inward) as it extends in the direction toward the second side Z2 in the axial direction. As shown in FIG. 32, the protrusion 544 includes a base part 544B and a claw part 544N.

The base part 544B protrudes from the second bridge member 542 toward the second side Z2 in the axial direction. The claw part 544N protrudes from a tip end of the base part 544B toward the outer side Y1 in the radial direction (radially outward). An inclined surface is formed at (on) the tip end of the claw part 544N. When mounting the support member 50c on the first insulation part 71c, as the support member 50c is moved toward the first insulation part 71c, the inclined surface of the claw part 544N comes into contact with the inclined surface 712C of the first outer wall part 712. As the support member 50c moves closer to the first insulation part 71c, the claw part 544N is pushed from the inclined surface 712C toward the second side Z2 in the axial direction, and then, due to elasticity of the second bridge member 542, the claw part 544N elastically rebounds (returns) toward the second side Z2 in the axial direction. When the movement toward the second side Z2 in the axial direction in the support member 50c has been completed, the second bridge member 542 and the claw part 544N return to their original positions such that the claw part 544N is engaged with (in) the through hole 717.

According to the motor 310c of the present embodiment, the through hole 717 for engaging the protrusion 544 of the support member 50c is formed in the wall surface on the inner side Y2 in the radial direction of the first outer wall part 712 of the first insulation part 71c. Because the first insulation part 71c is engaged with the support member 50c, it is possible to restrict (block) the support member 50c from moving in the axial direction DZ and in the circumferential direction DX relative to the first insulation part 71c. Thus, the connection member 52 and the support member 50c can be disposed on the stator 100c in a stable state (manner). Furthermore, because the through hole 717 is provided in the wall surface of the first outer wall part 712 (more specifically, between the end portion on the first side Z1 in the axial direction of the first outer wall part 712 and the end portion on the second side Z2 in the axial direction), the engagement position between the first insulation part 71c and the support member 50c can be arranged (located) further toward the second side Z2 in the axial direction than the outer apex parts 712T. Thus, the outer apex parts 712T and the end portion on the first side Z1 in the axial direction of the support member 50c can be (extend) in the same plane, and the configuration on the first side Z1 in the axial direction of the motor 310c can be simplified with fewer projections and recesses.

The through hole 717 may be formed in one of the medium wall portions 712M or one of the shortest wall portions 712S instead of in one of the longest wall portions 712L, or in addition to in one of the longest wall portions 712L. Further, in FIG. 31, an example is shown in which the first insulation part 71c includes the single through hole 717. However, as was noted above, in alternate embodiments of the present teachings, a plurality of the through holes 717, such as two or more, may be provided with a corresponding number of protrusions 544. Furthermore, the first insulation part 71c may include a recess (or recesses) corresponding (complementary) to the shape of the protrusion(s) 544 in a (radially inner) wall surface on the inner side Y2 in the radial direction of the first outer wall part 712, in place of the through hole(s) 717, or in addition to the through hole(s) 717. The recess(es) corresponding to the shape of the protrusion(s) 544 is (are) an example of a “second engagement part” according to the present teachings.

### D. Other Embodiments

(D1) In each of the above-described embodiments, the electrical insulation body 70 of the stator 100 is formed by insert molding, and in FIG. 6, an example is shown in which the first insulation part 71, the second insulation part 72, and the third insulation part 73 are formed in an integrated (integral) state; i.e. there is no seam between the first insulation part 71, the second insulation part 72 and the third insulation part 73. However, as will be described below, electrical insulation bodies for the stator according to the present disclosure are not limited to such an electrical insulation body in which the first insulation part 71, the second insulation part 72, and the third insulation part 73 are integrated.

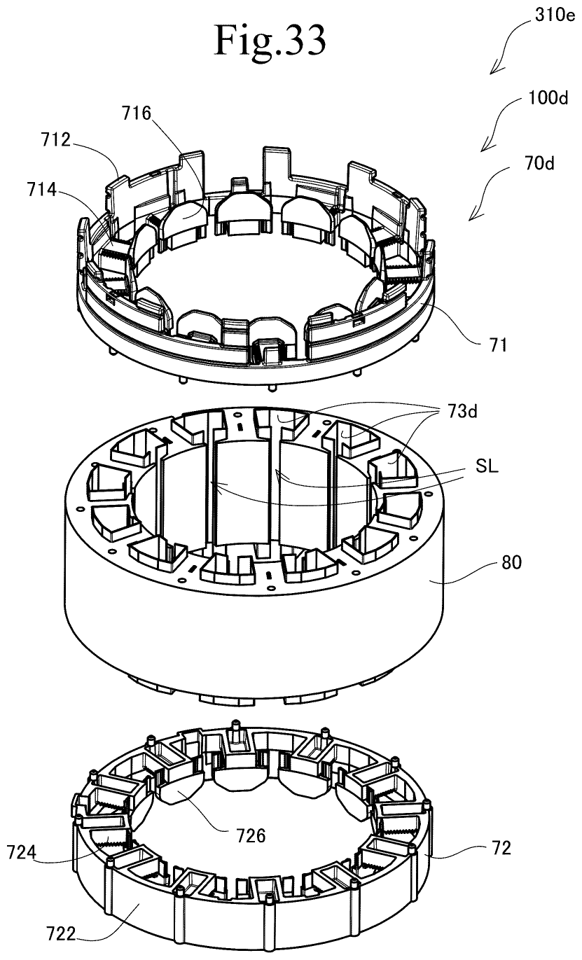

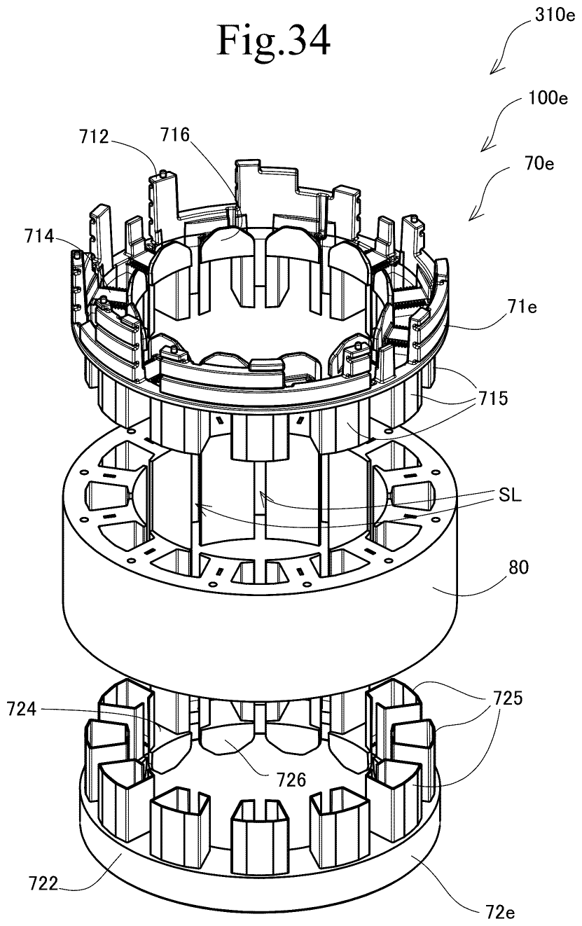

FIG. 33 is an exploded perspective view showing the configuration of a stator 100d included in a motor 310d according to another embodiment. The stator 100d includes the stator core 80, an electrical insulation body 70d, and the stator windings 90. In FIG. 33, and in FIG. 34 to be described below, for ease of understanding of the technology, the rotor 200 and the stator windings 90 are not illustrated. The configuration of the stator core 80 and the stator windings 90 are the same as those of the above-described first embodiment and a description thereof is thus omitted here.

The electrical insulation body 70d includes the first insulation part 71, the second insulation part 72, and third insulation parts 73d. The electrical insulation body 70d differs from the electrical insulation body 70 shown in the first embodiment in that the electrical insulation body 70d includes the third insulation parts 73d in place of the third insulation part 73. The remaining configuration is the same as that of the electrical insulation body 70.

In the present embodiment, the first insulation part 71, the second insulation part 72, and the third insulation parts 73d may be separately formed by injection molding, instead of insert molding, and are configured as separate (discrete) bodies (structures). In the present embodiment, the electrical insulation body 70d is formed by individually mounting the separate first insulation part 71, second insulation part 72, and third insulation parts 73d on (in) the stator core 80. The shape, the function, and the like of the first insulation part 71 and the second insulation part 72 are the same as those of the above-described first embodiment and a description thereof is thus omitted here.

The third insulation parts 73d are each a sheet-shaped or film-shaped member that is elongated in the axial direction DZ. The third insulation parts 73d are made (composed) of polyethylene terephthalate (PET), polyethylene naphthalate (PEN), polyphenylene sulfide (PPS), polyester, or the like. The function of the third insulation parts 73d is the same as the function of the third insulation part 73 described above.

When mounting the electrical insulation body 70d on the stator core 80, the first insulation part 71 is fixed to the first side Z1 in the axial direction of the stator core 80, and the second insulation part 72 is fixed to the second side Z2 in the axial direction of the stator core 80. The third insulation parts 73d are respectively inserted into the slots SL of the stator core 80. After the electrical insulation body 70d has been mounted on the stator core 80, the stator windings (coils) 90 are wound on the stator core 80. The motor 310d including the stator 100d configured in this way can also exhibit the same effects as those of each of the above-described embodiments.

FIG. 34 is an exploded perspective view showing the configuration of a stator 100e included in a motor 310e according to another embodiment. The stator 100e includes the stator core 80, an electrical insulation body 70e, and the stator windings 90 (not shown in FIG. 34 for clarity purposes). The configuration of the stator core 80 and the stator windings 90 are the same as those of the above-described first embodiment and a description thereof is thus omitted here.

The electrical insulation body 70e differs from the electrical insulation body 70 shown in the first embodiment in that the electrical insulation body 70e includes a first insulation part 71e and a second insulation part 72e in place of the first insulation part 71, the second insulation part 72, and the third insulation part 73. The remaining configuration is the same as that of the electrical insulation body 70.

The electrical insulation body 70e further includes first slot insulation parts 715, in addition to the configuration of the first insulation part 71 shown in the first embodiment. The first slot insulation parts 715 extend from a surface of the first outer wall part 712, the first drum parts 714, and the first inner wall parts 716 on the second side Z2 in the axial direction toward the second side Z2 in the axial direction. The shape of the first slot insulation parts 715 at least substantially matches the shape on the first side Z1 in the axial direction formed by the inner wall part 732, the side wall part 734, and the tip end part 736 shown in the first embodiment.

The second insulation part 72e further includes second slot insulation parts 725, in addition to the configuration of the second insulation part 72 shown in the first embodiment. The second slot insulation parts 725 extend from the second outer wall part 722, the second drum part 724, and the second inner wall part 726 on the first side Z1 in the axial direction toward the first side Z1 in the axial direction. The shape of the second slot insulation parts 725 at least substantially matches the shape on the second side Z2 in the axial direction formed by the inner wall part 732, the side wall part 734, and the tip end part 736 shown in the first embodiment.

As shown in FIG. 34, to mount the electrical insulation body 70e on the stator core 80, the first insulation part 71e is fixed to the first side Z1 in the axial direction of the stator core 80 in a state in which the first slot insulation parts 715 are respectively inserted into the slots SL on the first side Z1 in the axial direction. Before or after mounting the first insulation part 71e on the stator core 80, the second insulation part 72e is fixed to the second side Z2 in the axial direction of the stator core 80 in a state in which the second slot insulation parts 725 are respectively inserted into the slots SL on the second side Z2 in the axial direction. By inserting the first slot insulation parts 715 and the second slot insulation parts 725 into the slots SL, the same functions and effects as the third insulation part 73 included in the electrical insulation body 70 shown in the above-described first embodiment are exhibited. After the electrical insulation body 70e has been mounted on the stator core 80, the stator windings (coils) 90 are wound on the respective teeth of the stator core 80. The motor 310e including the stator 100e configured in this way can also exhibit the same effects as those of each of the above-described embodiments.

(D2) In each of the above-described embodiments, examples were described in which the motor 310 is installed in a compressor for the vehicle. However, in additional embodiments of the present teachings, the motor 310 may be installed in an air conditioning unit or the like, e.g., for a residence or business.

(D3) In each of the above-described embodiments, examples were described in which the motor 310 includes the stator core 80 in which the yoke 82 and the teeth 84 are integrated (integral, i.e. formed without seams therebetween). However, in additional embodiments of the present teachings, the stator core 80 may be formed by coupling (joining, e.g., welding) together, in an annular shape, a plurality of stator core segments that each have prescribed circular arc shape in the circumferential direction DX. Each stator core segment has a circular-arc shaped yoke segment and a single tooth. Thus, the stator core 80 may be formed (assembled) by coupling together the plurality of stator core segments to form an annular shape.

(D4) In the above-described first embodiment, an example was described in which the wire connection parts 91q, 92q, and 93q are connected by the wire connection terminal 60 to serve as the neutral point. However, the wire connection parts 91q, 92q, and 93q may instead be connected to serve as the neutral point by a method that does not utilize the wire connection terminal 60. Methods for connecting the wire connection parts 91q, 92q, and 93q without using the wire connection terminal 60 include, for example, a method in which the wire connection parts 91q, 92q, and 93q are welded together, a method in which the wire connection parts 91q, 92q, and 93q are soldered together, or the like. In such embodiments, in place of the wire connection terminal 60, a resin (potting) material may be disposed in the recess 594. For example, the wire connection parts 91q, 92q, and 93q are first connected to serve as the neutral point in the recess 594, and then the resin material may be introduced into the recess 594 to harden (cover, shield, protect) the wire connection parts 91q, 92q, and 93q. In such an embodiment as well, it is possible to dispose the wire connection parts 91q, 92q, and 93q on the stator 100 in a stable manner via (on) the support member 50.

(D5) In the above-described first embodiment, an example was described in which the end portion (surface) 58B of the inner peripheral wall part 58, the bottom part 528 of the connection member 52, and the bottom part 59B of the wire connection terminal compartment 59 are configured to be (extend) in the same plane. However, the end portion 58B of the inner peripheral wall part 58, the bottom part 528 of the connection member 52, and the bottom part 59B of the wire connection terminal compartment 59 may instead be disposed so as not to be in the same plane with each other.

(D6) In the above-described first embodiment, an example was described in which, in the support member 50, the outer peripheral wall part 56 is configured to be in contact with the outer apex parts 712T and the flange 719 of the first insulation part 71, and the inner peripheral wall part 58 is configured to be in contact with the inner apex parts 716T. In other words, in the above-described first embodiment, the first insulation part 71 supports the peripheral edge on the outer side Y1 in the radial direction of the support member 50 and the peripheral edge on the inner side Y2 in the radial direction. However, in alternate embodiments of the present teachings, the outer peripheral wall part 56 may be configured to not be in contact with the outer apex parts 712T and the flange 719 of the first insulation part 71. The support member 50 may be configured to not include the outer peripheral wall part 56. Further, the inner peripheral wall part 58 may be configured to not be in contact with the inner apex parts 716T. The support member 50 may be configured to not include the inner peripheral wall part 58.

(D7) In the above-described first embodiment, an example was described in which the connection member 52 is connected to the support member 50. However, in alternate embodiments of the present teachings, the support member 50 need not be provided. In such an embodiment, at least a part of the connection member 52 is preferably supported by a member included in the stator 100. The length of the motor 310 configured in this way can also be shortened in the axial direction DZ compared to the related art.

(D8) In the above-described first embodiment, the heights of the first inner wall parts 716 in the axial direction DZ, that is, the positions of the inner apex parts 716T in the axial direction DZ, are uniform. However, in alternate embodiments of the present teachings, the heights of the first inner wall parts 716 need not be uniform. For example, the bottom part 528 of the connection member 52 and bottom parts of each of parts included in the support member 50 may be adjusted (modified) to be at positions corresponding to the heights of the first inner wall parts 716. The motor 310 configured in this way can also obtain the same effects as those of the above-described first embodiment.

The present disclosure is not limited to the structures described in the above embodiments, and can be realized by various configurations insofar as they do not depart from the gist and scope of the present invention. For example, technical features in the embodiments corresponding to technical features in each of aspects listed in the Summary above can be switched, or combined, as appropriate in order to solve one, some or all of the above-described problems, or in order to achieve one, some or all of the above-described effects. Further, insofar as those technical features are not described as being essential in the present specification, they can be omitted as appropriate.

Furthermore, in view of the gist of the present invention, of the above-described embodiments, and the modified examples thereof, the following aspects of the present teachings are additionally provided. At least one of the following aspects can be utilized individually, or in combination with at least one of the features of the motors 310, 310b, 310c, 310d, and 310e and the compressor 300 of the above-described embodiments and the modified examples, or with at least one of the features disclosed in each of the claims herein.

### Aspect A1

The outer peripheral wall part includes an (at least one) outer wall projection protruding toward an inner side in a radial direction (radially inward) and extending in a circumferential direction, and
the outer wall part includes an (at least one) outer wall recess into which the (at least one) outer wall projection is (configured to be) fitted (inserted).

The outer wall projections 564 are an example of an “outer wall projection” according to the present teachings, and the outer wall recesses 712V are an example of an “outer wall recess” according to the present teachings.

According to a motor of this aspect, because the outer wall projection(s) is (are respectively) mated with (inserted into) the outer wall recess(es), movement of the outer peripheral wall part in the circumferential direction is restricted (blocked), whereby a connection member and a support member can be disposed on a stator in a stable state (manner).

Further, as one non-limiting object to provide a technique that contributes to a simplification of the structure of the lead wire part(s) in a motor, the following Aspects B1 to B16 are provided. Any one of the following Aspects B1 to B16 can be utilized individually, or two or more of the following Aspects B1 to B16 can be utilized in combination with each other. Alternatively, at least one of the following Aspects B1 to B16 can be utilized in combination with at least one of the motors 310, 310b, 310c, 310d, and 310e and the compressor 300 of the above-described aspects and embodiments, with the above-described modified examples, Aspect A1, or the features disclosed in each of the claims herein.

### Aspect B1

A motor comprising:
a stator having a cylindrical shape and extending in an axial direction;
a connection member disposed on a first side in the axial direction of the stator, the connection member being configured to house (accommodated, hold) a (at least one) connection terminal electrically connected to a (at least one) conductive terminal from a power supply; and
a support member supported on the stator on the first side in the axial direction of the stator, the support member being continuous with the connection member and supporting the connection member on the first side in the axial direction of the stator,
wherein:
the stator includes:
   a stator core including a yoke extending in a circumferential direction, and teeth extending from the yoke toward an inner side in a radial direction (radially inward),
   an electrical insulation body mounted on the stator core, and
   one or more stator windings, (each) including (i) a coil wound on the stator core via (over) the electrical insulation body, and (ii) a lead wire part that includes a first end portion of the stator winding and that is electrically connected to the coil and the connection terminal,
   the support member is composed of an electrically insulating material, and includes a lead wire compartment configured to guide the lead wire part(s) to the connection member.

### Aspect B2

The motor as defined in Aspect B1, wherein the lead wire compartment includes (i) a first lead-in hole (or a plurality of first lead-in holes respectively) guiding the lead wire part(s) from the stator toward the first side in the axial direction of the support member, and (ii) a first groove (or a plurality of first grooves respectively) extending from the first lead-in hole(s) to the connection member, the lead wire part(s) being (respectively) placed (held, disposed) in the first groove(s).

### Aspect B3

The motor as defined in Aspect B2, further comprising:
a cover member including a lead wire lid part covering the first groove(s).

### Aspect B4

The motor as defined in Aspect B1, wherein the support member is configured to (i) come into contact with a portion of the electrical insulation body disposed on the first side in the axial direction of the stator, and (ii) be supported at the first side in the axial direction of the electrical insulation body by the electrical insulation body with which contact is made.

### Aspect B5

The motor as defined in Aspect B4, wherein:
each of the teeth includes:
   a tooth base part extending from the yoke toward the inner side in the radial direction (radially inward), and
   a tooth tip part that is continuous with a radially-inward tip end of the tooth base part,
the electrical insulation body includes:
   an outer wall part disposed on an end portion on the first side in the axial direction of the yoke, and extending toward the first side in the axial direction,
   drum parts respectively disposed on end portions (surfaces) on the first side in the axial direction of the tooth base parts, and
   inner wall parts respectively disposed on end portions (surfaces) on the first side in the axial direction of the tooth tip parts, and extending toward the first side in the axial direction,
the support member includes an inner peripheral wall part continuous with the lead wire compartment and extending in the circumferential direction,
each of the inner wall parts includes an inner apex part on an end portion (surface) on the first side in the axial direction of the inner wall part, and
the inner peripheral wall part of the support member is configured to (i) come into contact with at least one of the inner apex parts, and (ii) be supported on the first side in the axial direction of the electrical insulation body by the inner apex parts with which contact is made.

### Aspect B6

The motor as defined in Aspect B5, wherein:
the support member includes an outer peripheral wall part continuous with the lead wire compartment and extending in the circumferential direction,
the outer wall part includes one or more outer apex parts on (at) an end portion (or end portions) on the first side in the axial direction of the outer wall part,
the outer peripheral wall part of the support member is configured to (i) come into contact with at least one of the outer apex part(s) and the stator core, and (ii) be supported on the first side in the axial direction of the electrical insulation body by the at least one of the outer apex part(s) and the stator core with which contact is made.

### Aspect B7

The motor as defined in Aspect B1, wherein the support member is configured to engage with a part of the electrical insulation body.

### Aspect B8

The motor as defined in Aspect B1, wherein the stator windings include a Y-connected part in which second end portions of the respective stator windings on an opposite end from the first end portions of the respective stator windings are connected as a neutral point.

### Aspect B9

The motor as defined Aspect B8, further comprising:
a wire connection compartment, wherein:
the stator windings include one or more wire connection parts in which the second end portions are connected for forming the neutral point,
the wire connection compartment defines a recess configured to accommodate (hold) the wire connection part(s), and
the support member supports the wire connection compartment on the first side in the axial direction of the stator.

### Aspect B10

The motor as defined in Aspect B9, wherein the wire connection compartment includes (i) at least one second lead-in hole configured to guide the second end portion of one of the stator windings from the stator core toward the first side in the axial direction of the support member, and (ii) a second groove extending from the second lead-in hole to the recess, the second end portion of the one of the stator windings being placed (disposed) in the second groove.

### Aspect B11

The motor as defined in Aspect B9, further comprising:
a cover member including a wire connection lid part covering the wire connection compartment.

### Aspect B12

The motor as defined in Aspect B9, wherein at least one of the lead wire part(s) and the second end portion(s) of the stator windings does not include an insulation tube covering the at least one of the lead wire part(s) and the second end portion(s); i.e. no insulation tube is provided to cover (insulate) at least one of the lead wire part(s) and the second end portion(s), e.g., on a radially outer side thereof.

### Aspect B13

The motor as defined in Aspect B1, wherein the motor includes a delta-connection part in which second end portions of the stator windings, on the opposite end from the respective first end portions of the stator windings, are connected to each other.

### Aspect B14

The motor as defined in Aspect B13, wherein the lead wire part(s) and the second end portion(s) do not include an insulation tube covering the lead wire part(s) and the second end portion(s); i.e. no insulation tube is provided to cover (insulate) at least one of the lead wire part(s) and the second end portion(s), e.g., on a radially outer side thereof.

### Aspect B15

The motor as defined in any one of Aspects B1 to B14, wherein the motor is configured to be used in a compressor installed in a vehicle.

### Aspect B16

A compressor including a compression mechanism configured to compress a fluid and to discharge compressed (pressurized) fluid, and a motor configured to drive the compression mechanism, wherein the motor is any one of the motors according to any one of Aspects B1 to B15 or any one of the above-described aspects and embodiments.

Correspondences between each of the structural elements (features) of Aspects B1 to B16 and each of structural elements (features) of the present disclosure or invention are as indicated below. However, it should be understood that each of the structural elements of the embodiments is merely an example, and does not limit each of the structural elements of Aspects B1 to B16.

The motors 310, 310b, 310c, 310d, and 310e are an example of a “motor”. The stators 100, 100b, 100c, 100d, and 100e are an example of a “stator”. The power supply circuit 340, the conductive terminal 342, and the connection terminal 94 are an example of a “power supply”, a “conductive terminal”, and a “connection terminal”, respectively. The connection member 52 and the support members 50, 50b, and 50c are an example of a “connection member” and a “support member”, respectively. The lead wire parts 90p, 91p, 91p2, 92p, 92p2, 93p, and 93p2 are each an example of a “lead wire part”. The lead wire compartment 55 is an example of a “lead wire compartment”. The lead-in holes 551H, 552H, and 553H are each an example of a “first lead-in hole”. The grooves 551, 552, and 553 are each an example of a “first groove”. The second lid part 46 and the cover members 40 and 40b are an example of a “lead wire lid part” and a “cover member”, respectively. The first outer wall part 712, the first drum parts 714, and the first inner wall parts 716 are an example of an “outer wall part”, a “drum part” and an “inner wall part”, respectively. The inner peripheral wall part 58 and the inner apex part 716T are an example of an “inner peripheral wall part” and an “inner apex part”, respectively. The outer peripheral wall part 56 and the outer apex part 712T are an example of an “outer peripheral wall part” and an “outer apex part”, respectively. The wire connection terminal compartment 59, the recess 594, the lead-in hole 590, and grooves 591, 592, and 593 are an example of a “wire connection compartment”, a “recess”, a “second lead-in hole”, and a “second groove”, respectively. The wire connection parts 90q, 91q, 92q, and 93q are each an example of a “wire connection part”. The third lid part 48 and the cover member 40 are an example of a “wire connection lid part” and the “cover member”, respectively.

### DESCRIPTION OF THE REFERENCE NUMERALS

22: Magnet
24: Rotor core
40, 40b: Cover member
42: Opening
44, 44b: First lid part
46: Second lid part
47: Outer peripheral wall part
47H: Opening
48: Third lid part
50, 50b, 50c: Support member
52: Connection member
52S: Terminal space
54: Bridge member
55, 55b: Lead wire compartment
55H: Opening
56, 56b: Outer peripheral wall part
56B: End portion (surface)
56H: Opening
58, 58b: Inner peripheral wall part
58B: End portion (surface)
59: Wire connection terminal compartment
59B: Bottom part
60: Wire connection terminal
61, 62, 63: Terminal insertion part
64: Main body
70, 70b, 70c, 70d, 70e: Electrical insulation body
71, 71b, 71c, 71e: First insulation part
72, 72e: Second insulation part
73, 73d: Third insulation part
80: Stator core
82: Yoke
84: Teeth
90: Stator winding
90T: End portion (surface)
90p, 91p, 91p2, 92p, 92p2, 93p, 93p2: Lead wire part
90q, 91q, 92q, 93q: Wire connection part
94: Connection terminal
100, 100b, 100c, 100d, 100e: Stator
200: Rotor
300: Compressor
301: Housing
303: Motor chamber
304: Communication path
305: Discharge port
310, 310b, 310c, 310d, 310e: Motor
320: Compression mechanism
322: Fixed scroll
324: Movable scroll
330: Drive shaft
332: Eccentric pin
340: Power supply circuit
342: Conductive terminal
421: Opening
442: Inclined part
442R: Wall surface
521, 522, 523: Terminal space
526: Side wall part
526T: Inclined part
528: Bottom part
528L: Virtual line
541: First bridge member
542: Second bridge member
543: Opening
544: Protrusion
544B: Base part
544N: Claw part
551, 552, 553: Groove
551H, 552H, 553H: Lead-in hole
558: Bottom part
560: Main body
562, 562b: Outer peripheral wall flange
564: Outer wall projection
590: Lead-in hole
591, 592, 593: Groove
594: Recess
712, 712b: First outer wall part
712B: Bottom wall part
712C: Inclined surface
712L: Longest wall portion
712L1: First longest wall portion
712L2: Second longest wall portion
712M, 712M1, 712M2: Medium wall portion
712R: Groove
712S: Shortest wall portion
712ST: Shortest outer apex part
712T: Outer apex part
712V: Outer wall recess
712W: Outer peripheral surface
713: Protrusion
714: First drum part
715: First slot insulation part
716: First inner wall part
716T: Inner apex part
717: Through hole
718: Engagement part
718B: Base part
718N: Claw part
719: Flange
722: Second outer wall part
724: Second drum part
725: Second slot insulation part
726: Second inner wall part
732: Inner wall part
734: Side wall part
736: Tip end part
842: Tooth base part
844F1: First flange
844: Tooth tip part
844W: Tip end surface
844F2: Second flange
AX Rotational axis
LC Laser oscillator
LS Laser light
R1 Inclination angle
SL Slot

What is claimed is:

1. A motor comprising:
a stator having a cylindrical shape and extending in an axial direction;
a connection member disposed on a first side in the axial direction of the stator, the connection member being configured to accommodate at least one connection terminal that is configured to be electrically connected to at least one conductive terminal from a power supply; and
a support member supported on the stator on the first side in the axial direction of the stator, the support member being continuous with the connection member and supporting the connection member on the first side in the axial direction of the stator,
wherein:
the stator includes:
a stator core having a yoke extending in a circumferential direction, and teeth extending radially inward from the yoke;
an electrical insulation body mounted on the stator core; and
at least one stator winding that includes (i) a coil wound on the stator core via or over the electrical insulation body, and (ii) a lead wire part that includes a first end portion of the stator winding and is electrically connected to the coil and the at least one connection terminal; and
the support member is composed of an electrically insulating material, and includes a lead wire compartment that guides the lead wire part to the connection member.

2. The motor as defined in claim 1, wherein the lead wire compartment includes (i) a first lead-in hole guiding the lead wire part from the stator toward the first side in the axial direction of the support member, and (ii) a first groove extending from the first lead-in hole to the connection member, the lead wire part being disposed in the first groove.

3. The motor as defined in claim 2, further comprising:
a cover member including a lead wire lid part covering the first groove.

4. The motor as defined in claim 1, wherein the support member (i) directly contacts a portion of the electrical insulation body disposed on the first side in the axial direction of the stator, and (ii) is supported at the first side in the axial direction of the electrical insulation body by the electrical insulation body.

5. The motor as defined in claim 4, wherein:
each of the teeth has:
a tooth base part extending radially inward from the yoke; and
a tooth tip part continuous with a radially-inward tip end of the tooth base part,
the electrical insulation body includes:
an outer wall part disposed on an end portion on the first side in the axial direction of the yoke, and extending toward the first side in the axial direction;
at least one drum part disposed on an end portion on the first side in the axial direction of the tooth base part; and
at least one inner wall part disposed on an end portion on the first side in the axial direction of one of the tooth tip parts, and extending toward the first side in the axial direction;
the support member includes an inner peripheral wall part that is continuous with the lead wire compartment and extends in the circumferential direction;
the at least one inner wall part includes an inner apex part that is an end portion on the first side in the axial direction of the inner wall part; and
the inner peripheral wall part (i) directly contacts the inner apex part, and (ii) is supported on the first side in the axial direction of the electrical insulation body by the inner apex part.

6. The motor as defined in claim 5, wherein:
the support member includes an outer peripheral wall part that is continuous with the lead wire compartment and extends in the circumferential direction,
the outer wall part includes at least one outer apex part that is an end portion on the first side in the axial direction of the outer wall part,
the outer peripheral wall part (i) directly contact at least one of the outer apex part and the stator core, and (ii) is supported on the first side in the axial direction of the electrical insulation body by the at least one of the outer apex part and the stator core.

7. The motor as defined in claim 1, wherein the support member engages with a portion of the electrical insulation body.

8. The motor as defined in claim 1, wherein the at least one stator winding includes a Y-connected part in which a second end portion of the at least one stator winding, which is on an opposite end from the first end portion of the at least one stator winding, is connected with at least one other second end portion of another stator winding as a neutral point.

9. The motor as defined claim 8, further comprising:
a wire connection compartment,
wherein:
the second end portion of the at least one stator winding includes a wire connection part;
the wire connection compartment defines a recess configured to accommodate the wire connection part; and
the support member supports the wire connection compartment on the first side in the axial direction of the stator.

10. The motor as defined in claim 9, wherein the wire connection compartment includes (i) a second lead-in hole that guides the second end portion of the at least one stator winding from the stator core toward the first side in the axial direction of the support member, and (ii) a second groove extending from the second lead-in hole to the recess, and the second end portion being disposed in the second groove.

11. The motor as defined in claim 9, further comprising:
a cover member including a wire connection lid part covering the wire connection compartment.

12. The motor as defined in claim 9, wherein at least one of the lead wire part and the second end portion of the at least one stator winding do not include an insulation tube covering a radially outer side of the at least one of the lead wire part and the second end portion.

13. The motor as defined in claim 1, wherein the motor includes a delta-connection part in which second end portions of a plurality of stator windings, which are respectively on opposite end from the first end portions of the plurality of stator windings, are connected to each other.

14. The motor as defined in claim 13, wherein the lead wire part and the second end portion of the at least one stator winding do not include an insulation tube covering a radially outer side of the lead wire part and the second end portion.

15. The motor as defined in claim 1, wherein the motor is configured to be mounted in or on a compressor installed in a vehicle.

16. A compressor including:
a compression mechanism configured to compress a fluid and to discharge compressed fluid; and
the motor according to claim 1 configured to drive the compression mechanism.
